(19) United States
(12) Patent Application Publication
(10) Pub. No.: US 2024/0185163 A1
(43) Pub. Date: Jun. 6, 2024

(54) ABILITY EVALUATING APPARATUS

(71) Applicant: NTT DOCOMO, INC., Chiyoda-ku (JP)

(72) Inventors: Yuki KATSUMATA, Chiyoda-ku (JP); Hiroaki TANAKA, Chiyoda-ku (JP); Kousuke KUBOTA, Chiyoda-ku (JP)

(73) Assignee: NTT DOCOMO, INC., Chiyoda-ku (JP)

(21) Appl. No.: 18/553,784

(22) PCT Filed: Mar. 18, 2022
(86) PCT No.: PCT/JP2022/012730

§ 371 Date: Oct. 3, 2023

(30) Foreign Application Priority Data
Apr. 22, 2021 (JP) 2021-072814

(51) Int. Cl. G06Q 10/0639

(52) U.S. Cl. CPC G06Q 10/06398

(57) ABSTRACT

The present invention includes: a first data acquirer configured to, based on conversation data in a chat system, acquire a number of mentions provided by an evaluation target member of one team to each team within a first period; a first calculator configured to, based on the number of mentions provided by the evaluation target member to each team calculate a first proportion that is a proportion of the number of mentions provided by the evaluation target member to each team; and an estimator configured to, based on a relationship between a second proportion and a second indicator value, estimate a first indicator value corresponding to the first proportion, the second proportion being a proportion of a number of mentions provided by one member among a plurality of members of the organization to each team within a second period previous to the first period, the second indicator value being indicative of work engagement of the one member, the first indicator value being indicative of work engagement of the evaluation target member.

### TECHNICAL FIELD

The present invention relates to an ability evaluating apparatus.

### BACKGROUND ART

Companies must manage their organizations. For example, to employ a new employee, a company calculates a job seeker's aptitude for a job using a score such as an outcome of a Synthetic Personality Inventory (SPI). A company may use a system that manages a project based on organizational distance between a manager and a managed person.

For example, Patent Document 1 discloses a talent identification system available to assist in the recruitment process for new employees. This talent identification system uses an array of neuroscience-based tests to assess a user's career tendencies. Patent Document 2 discloses a project management system that transmits a message at a notification timing determined from information on organizational distance between a project leader and a project member. Here, “information on organizational distance” means organizational distance based on a distance between the project leader and the project member in a tree structure representative of a configuration of an organization.

### RELATED ART DOCUMENT

### Patent Document

### Patent Document 1: Japanese Patent Application Laid-Open Publication (Translation of PCT Application) No. 2019-508776

### Patent Document 2: Japanese Patent Application Laid-Open Publication No. 2020-154739

### SUMMARY OF THE INVENTION

### Problem to be Solved by the Invention

However, to calculate a score such as a job seeker's aptitude for a job, it is necessary to ask the target person who is to be scored to input information for the test described above, for example. As a result, the target person has a burden of the input. In a state in which a project is managed based on organizational distance between a manager and a managed person, the management is assisted by information that hardly changes on a daily basis or on a monthly basis, such as organizational distance. Thus, there is a problem in that a subtle change in a managed person cannot be understood.

### Means for Solving Problem

An ability evaluating apparatus according to a preferred aspect of the present invention includes: a first data acquirer configured to, based on conversation data in a chat system, acquire a number of mentions, the chat system being used by an organization constituted of a plurality of teams, the mentions being provided by an evaluation target member to each of the plurality of teams within a first period, the evaluation target member being a member of one of the plurality of teams; a first calculator configured to, based on the number of mentions provided by the evaluation target member to each of the plurality of teams, calculate a first proportion that is a proportion of the number of mentions provided by the evaluation target member to each of the plurality of teams; and an estimator configured to, based on a relationship between a second proportion and a second indicator value, estimate a first indicator value corresponding to the first proportion, the second proportion being a proportion of a number of mentions provided by one member among a plurality of members of the organization to each of the plurality of teams within a second period previous to the first period, the second indicator value being indicative of work engagement representative of a work-related state of mind of the one member among the plurality of members, the first indicator value being indicative of work engagement of the evaluation target member.

### Effect of Invention

According to the present invention, in a case in which a work ability of a target person is evaluated, it is possible not only to reduce a burden on the target person, but also to understand quick changes in the target person.

### BRIEF DESCRIPTION OF THE DRAWINGS

FIG. 1 is a diagram showing an overall configuration of an ability evaluating system 1 according to an embodiment.

FIG. 2 is a block diagram showing an example of a configuration of an ability evaluating apparatus 10 according to the embodiment.

FIG. 3 is a diagram explaining the number of mentions provided by a new member to each team in the embodiment.

FIG. 4A is a diagram explaining an example of a conversation via user terminal devices 30-1 through 30-n that use a chat system in the embodiment.

FIG. 4B is a diagram explaining another example of a conversation via the user terminal devices 30-1 through 30-n that use the chat system in the embodiment.

FIG. 5 is a block diagram showing an example of a configuration of a server 20 according to the embodiment.

FIG. 6 is a diagram explaining an example of a configuration of a mention history database DB1 according to the embodiment.

FIG. 7 is a diagram explaining an example of a configuration of a mention content database DB2 according to the embodiment.

FIG. 8 is a diagram explaining an example of a configuration of a user information database DB3 according to the embodiment.

FIG. 9 is a block diagram showing an example of a configuration of a user terminal device 30 according to the embodiment.

FIG. 10 is a flowchart showing an operation of the ability evaluating apparatus 10 according to the embodiment during machine learning.

FIG. 11A is a flowchart showing an operation of the ability evaluating apparatus 10 according to the embodiment during use.

FIG. 11B is a flowchart showing another operation of the ability evaluating apparatus 10 according to the embodiment during use.

FIG. 11C is a flowchart showing yet another operation of the ability evaluating apparatus 10 according to the embodiment during use.

FIG. 12 is a box plot of levels of work engagement of each team in the embodiment.

FIG. 13 is a graph of a value of mutual information for each feature in the embodiment.

FIG. 14 is a graph of relationship between predicted values output from a trained model according to the embodiment and true values.

FIG. 15 is an example of display of process data generated by the ability evaluating apparatus 10 according to the embodiment on a display 140 or on a display 330.

FIG. 16 is another example of display of process data generated by the ability evaluating apparatus 10 according to the embodiment on the display 140 or on the display 330.

FIG. 17 is yet another example of display of process data generated by the ability evaluating apparatus 10 according to the embodiment on the display 140 or on the display 330.

FIG. 18 is yet another example of display of process data generated by the ability evaluating apparatus 10 according to the embodiment on the display 140 or on the display 330.

FIG. 19 is yet another example of display of process data generated by the ability evaluating apparatus 10 according to the embodiment on the display 140 or on the display 330.

FIG. 20 is yet another example of display of process data generated by the ability evaluating apparatus 10 according to the embodiment on the display 140 or on the display 330.

FIG. 21 is yet another example of display of process data generated by the ability evaluating apparatus 10 according to the embodiment on the display 140 or on the display 330.

FIG. 22 is yet another example of display of process data generated by the ability evaluating apparatus 10 according to the embodiment on the display 140 or on the display 330.

FIG. 23 is yet another example of display of process data generated by the ability evaluating apparatus 10 according to the embodiment on the display 140 or on the display 330.

FIG. 24 is yet another example of display of process data generated by the ability evaluating apparatus 10 according to the embodiment on the display 140 or on the display 330.

FIG. 25 is yet another example of display of process data generated by the ability evaluating apparatus 10 according to the embodiment on the display 140 or on the display 330.

FIG. 26 is yet another example of display of process data generated by the ability evaluating apparatus 10 according to the embodiment on the display 140 or on the display 330.

### MODES FOR CARRYING OUT THE INVENTION

### 1. Configuration of Embodiments

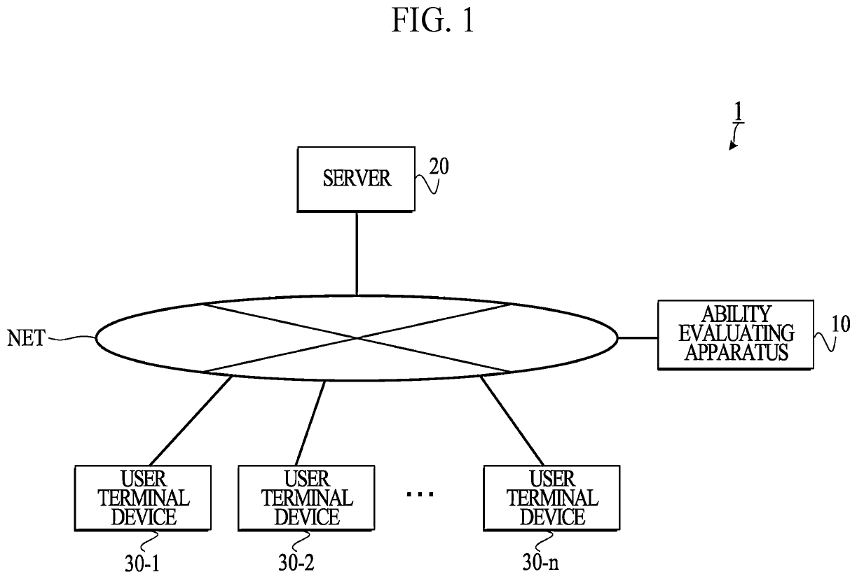

With reference to FIG. 1 through FIG. 9, a configuration of an ability evaluating apparatus and a configuration of an ability evaluating system according to an embodiment of the present invention will be explained below.

### 1.1 Overall Configuration

FIG. 1 is a diagram showing an overall configuration of an ability evaluating system 1 according to the embodiment of the present invention. The ability evaluating system 1 is a system configured to evaluate, based on conversation data in a chat system used by an organization constituted of a plurality of teams, the work ability of a member of the organization.

The ability evaluating system 1 includes an ability evaluating apparatus 10, a server 20, and n user terminal devices 30-1 through 30-n that comprise an example of a plurality of user terminal devices 30, where n is an integer of two or more.

The ability evaluating apparatus 10 is a device configured to evaluate the work ability of the member based on the conversation data in the chat system, the conversation data being acquired from the server 20. Specifically, the ability evaluating apparatus 10 determines, from the conversation data, the number of mentions of the member, a relationship between a speaker and a listener, etc., to evaluate the work ability of the member based on a result of the determination.

The server 20 provides the chat system used by n members. The n members use the user terminal devices 30-1 through 30-n, respectively. The server 20 processes the conversation data in the chat system to generate data, and the server 20 outputs the data to the ability evaluating apparatus 10.

Each of the user terminal devices 30-1 through 30-n is a terminal device used by one of the members, who is a user. The n members use the user terminal devices 30-1 through 30-n respectively to use the chat system provided by the server 20. Each of the members uses the chat system to have a chat, in other words, to exchange mentions input from each of the user terminal devices 30-1 through 30-n. The user terminal devices 30-1 through 30-n include a user terminal device 30 that is permitted to access the ability evaluating apparatus 10, and the user terminal device 30 acquires an indicator value of work ability of each of the members that use the user terminal devices 30-1 through 30-n from the ability evaluating apparatus 10. The user terminal device 30 that is permitted to access the ability evaluating apparatus 10 is, for example, a terminal device used by a manager. Furthermore, the user terminal device 30 that is permitted to access the ability evaluating apparatus 10 displays the acquired respective indicator values of work ability on a display.

### 1.2 Configuration of Ability Evaluating Apparatus

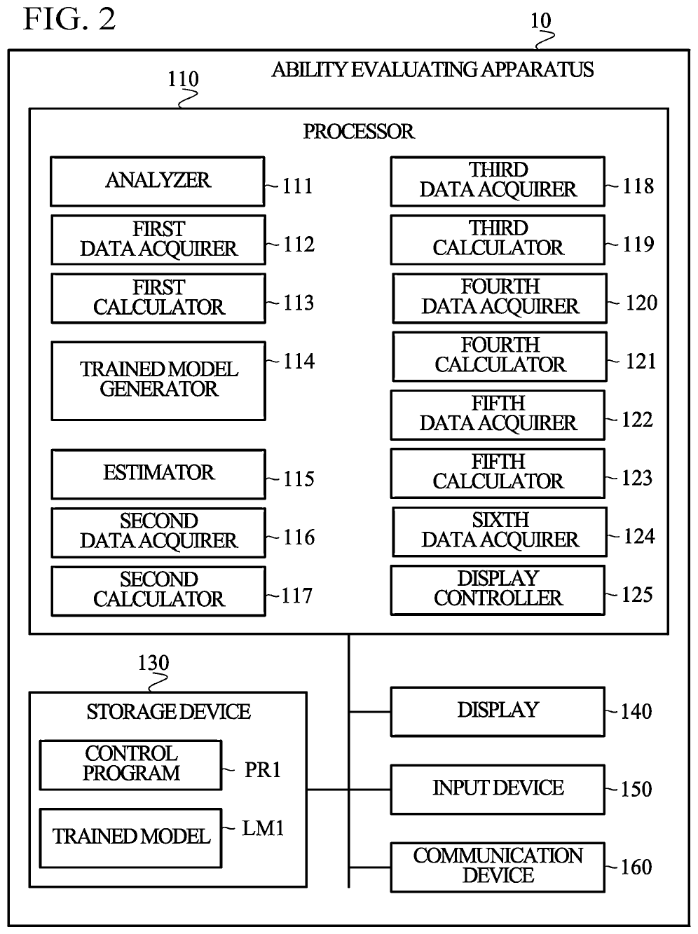

FIG. 2 is a block diagram showing an example of a configuration of the ability evaluating apparatus 10. The ability evaluating apparatus 10 is typically a personal computer (PC). However, the ability evaluating apparatus 10 is not limited to a PC, and may be a tablet terminal or a smartphone, for example. The ability evaluating apparatus 10 includes a processor 110, a storage device 130, a display 140, an input device 150, and a communication device 160. Each element of the ability evaluating apparatus 10 is interconnected by a single bus or by multiple buses for communicating information.

The processor 110 is a processor configured to control the entire ability evaluating apparatus 10. The processor 110 is constituted of a single chip or of multiple chips, for example. The processor 110 is constituted of a central processing unit (CPU) that includes, for example, interfaces for peripheral devices, arithmetic units, registers, etc. One, some, or all of the functions of the processor 110 may be implemented by hardware such as a digital signal processor (DSP), an application specific integrated circuit (ASIC), a programmable logic device (PLD), and a field programmable gate array (FPGA). The processor 110 executes various processing in parallel or sequentially.

The storage device 130 is a recording medium readable and writable by the processor 110. The storage device 130 stores a plurality of programs. The plurality of programs includes a control program PR1 to be executed by the processor 110. The storage device 130 further stores a program that defines a trained model LM1. The program that defines the trained model LM1 includes multiple coefficients adjusted by machine learning. In FIG. 2, the program that defines the trained model LM1 is referred to as the trained model LM1. The trained model LM1 is generated by a trained model generator 114 described below. The storage device 130 may be constituted of, for example, at least one of a read only memory (ROM), an erasable programmable ROM (EPROM), an electrically erasable programmable ROM (EEPROM), a random access memory (RAM), etc. The storage device 130 may be referred to as a register, a cache, a main memory, or a main storage device, etc.

The display 140 is a device configured to display images and character information. The display 140 displays various images under control executed by the processor 110. For example, various display panels, such as liquid crystal display panels, and organic electroluminescent (EL) display panels, are suitably used as the display 140.

The input device 150 is a device configured to receive an operation made by a user. For example, the input device 150 includes a keyboard and a pointing device such as a touch pad, a touch panel, or a mouse. Here, the input device 150, which includes a touch panel, may serve as the display 140.

The communication device 160 is a transmitting and receiving device configured to communicate with other devices. The transmitting and receiving device is hardware. For example, the communication device 160 may be referred to as a network device, a network controller, a network card, a communication module, etc. The communication device 160 may include a connector for wired connection and an interface circuit corresponding to the connector for wired connection. The communication device 160 may include a wireless communication interface. The connector for wired connection and the interface circuit may conform to wired LAN, IEEE1394, or USB. The wireless communication interface may conform to wireless LAN or Bluetooth (registered trademark), etc.

The processor 110 reads the control program PRI from the storage device 130. The processor 110 executes the control program PR1 to function as an analyzer 111, a first data acquirer 112, a first calculator 113, the trained model generator 114, an estimator 115, a second data acquirer 116, a second calculator 117, a third data acquirer 118, a third calculator 119, a fourth data acquirer 120, a fourth calculator 121, a fifth data acquirer 20 122, a fifth calculator 123, a sixth data acquirer 124, and a display controller 125. The control program PRI may be transmitted from another device, such as a server configured to manage the ability evaluating apparatus 10, to the processor 110 via a communication network NET. The processor 110 reads the program that defines the trained model LM1, etc., from the storage 25 device 130. The processor 110 executes the program that defines the trained model LM1, etc., to function as the trained model LM1.

The analyzer 111 makes a request to the server 20 for data necessary to calculate various indicator values related to work ability of a member. The analyzer 111 acquires a response to the request from the server 20. The analyzer 111 performs an analysis of data included in the response to output a result of the analysis.

For example, the user of the ability evaluating apparatus 10 uses the input device 150 to input an ID of a new member and a period D1 for conversation data. The new member is a member who newly joins one team of the plurality of teams. The new member is an example of an evaluation target member. The evaluation target member is not limited to new members. The evaluation target member may be a member different from the new member. The period D1 for conversation data is a period of time in which conversation data is collected that is required to estimate work engagement of the new member. The analyzer 111 acquires the ID of the new member and the period D1 for conversation data from the input device 150. An example of the period D1 for conversation data is a period of time from a point in time at which the new member joins the one team to a point in time previous to a starting point in time of calculation of the work engagement of the new member.

The analyzer 111 provides the server 20 with a data request Rq1 that specifies the ID of the new member and the period D1 for conversation data.

The analyzer 111 acquires a data response Rs1 transmitted from the server 20 responsive to the data request Rq1. The analyzer 111 analyzes records included in the data response Rs1 to calculate the number of mentions of the new member within the period D1 for conversation data.

The analyzer 111 analyzes the records included in the data response Rs1 to calculate the number of mentions when on the team and the number of mentions when not on the team. The number of mentions when on the team is the number of mentions provided by the new member to one or more members of the team, the team including the new member. The number of mentions when not on the team is the number of mentions provided by the new member to one or more members of one or more teams, the one or more teams not including the new member.

The analyzer 111 analyzes the records included in the data response Rs1 to calculate, for each mention of the new member, the number of citations and a citation relationship. The number of citations is the number of citations from a mention of the new member. The citation relationship indicates a relationship between the new member and one or more members citing the mention of the new member.

The user of the ability evaluating apparatus 10 uses the input device 150 to input a period D2 for conversation data. The period D2 for conversation data is a period of time in which conversation data is collected that is required to calculate both an indicator value indicative of efficiency of each of the plurality of teams and an indicator value indicative of a degree of innovation due to each of the plurality of teams. The analyzer 111 acquires the period D2 for conversation data from the input device 150.

The analyzer 111 provides the server 20 with a data request Rq2 that specifies the period D2 for conversation data.

The analyzer 111 acquires a data response Rs2 transmitted from the server 20 responsive to the data request Rq2. The analyzer 111 analyzes records included in the data response Rs2 to calculate, for each team of the plurality of teams, a numerical value A1 of an external range and a numerical value A2 of degree centrality. The numerical value A1 of an external range is the number of members of one or more teams, the one or more teams being other than the team, the members of the one or more teams having had a conversation with one or more members of the team. The numerical value A1 of an external range is an example of a first numerical value of an external range. The numerical value A2 of degree centrality is the number of one or more teams other than the team, the one or more teams including a member having had a conversation with one or more members of the team. The numerical value A2 of degree centrality is an example of a first numerical value of degree centrality.

The user of the ability evaluating apparatus 10 uses the input device 150 to input a period D3 for conversation data. The period D3 for conversation data is a period of time in which conversation data is collected that is required to calculate both an indicator value indicative of a degree of siloing as a degree of isolation of each organization of a plurality of organizations and an indicator value indicative of vulnerability of each of the plurality of organizations versus another organization. The plurality of organizations is an example of a plurality of first organizations. Furthermore, the plurality of organizations is an example of a plurality of second organizations. The analyzer 111 acquires the period D3 for conversation data from the input device 150.

The analyzer 111 provides the server 20 with a data request Rq3 that specifies the period D3 for conversation data.

The analyzer 111 acquires a data response Rs3 transmitted from the server 20 responsive to the data request Rq3. The analyzer 111 analyzes records included in the data response Rs3 to calculate, for each of the plurality of organizations, a numerical value B1 of an external range and a numerical value B2 of degree centrality. The numerical value B1 of an external range is the number of members of one or more organizations, the one or more organizations being other than an organization, the members of the one or more organizations having had a conversation with one or more members of the organization. The numerical value B1 of external range is an example of a second numerical value of an external range. The numerical value B2 of degree centrality is the number of one or more organizations other than the organization, the one or more organizations including a member having had a conversation with one or more members of the organization. The numerical value B2 of degree centrality is an example of a second numerical value of degree centrality.

The analyzer 111 analyzes the records included in the data response Rs3 to acquire, for each organization of the plurality of organizations, the number of members of the organization having had a conversation with one or more members of a different organization from the organization, as an indicator value indicative of vulnerability against the different organization.

The first data acquirer 112 acquires, from the analyzer 111, the number of mentions provided by the new member to each of the plurality of teams within a period of time after the new member joins the one team. The period of time after the new member joins the one team is an example of a first period.

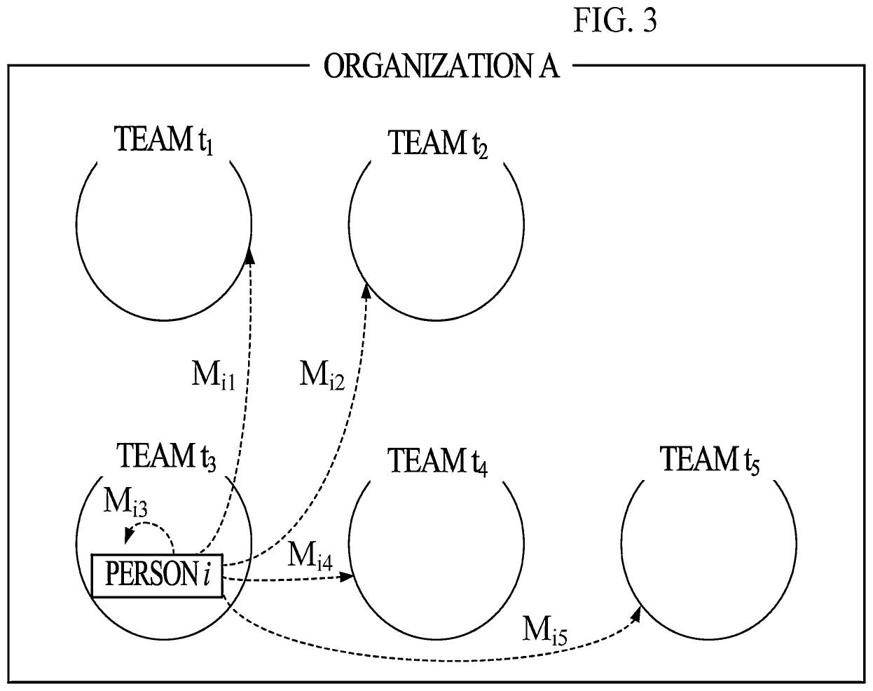

FIG. 3 is a diagram explaining the number of mentions provided by the new member to each of the plurality of teams. In FIG. 3, an organization A includes five teams constituted of teams t₁ through t₅. It is assumed that a person i, who is the new member, joins the team t₃, for example. In FIG. 3, the sum of the number of mentions provided by the person i to one or more respective members of the team t₁ is shown as the number of mentions Mᵢ₁ provided by the person i to the team t₁. Similarly, the sum of the number of mentions provided by the person i to one or more respective members of the team t₂ is shown as the number of mentions Mᵢ₂ provided by the person i to the team t₂. The sum of the number of mentions provided by the person i to one or more respective members of the team t₃ is shown as the number of mentions Mᵢ₃ provided by the person i to the team t₃. The sum of the number of mentions provided by the person i to one or more respective members of the team t₄ is shown as the number of mentions Mᵢ₄ provided by the person i to the team t₄. The sum of the number of mentions provided by the person i to one or more respective members of the team t₅ is shown as the number of mentions Mᵢ₅ provided by the person i to the team t₅. Here, the total number of members of the organization A is k, where k is an integer of two or more, and i is an integer satisfying 1≤i≤k.

The five teams constituted of the teams t₁ through t₅ are examples of a plurality of teams. The plurality of teams is not limited to the five teams constituted of the teams t₁ through t₅. When the organization A includes m teams t₁ through tₘ, the number of mentions provided by the person i to a team tⱼ is shown as Mᵢⱼ. Here, m is an integer of two or more, and j is an integer satisfying 1≤j≤m.

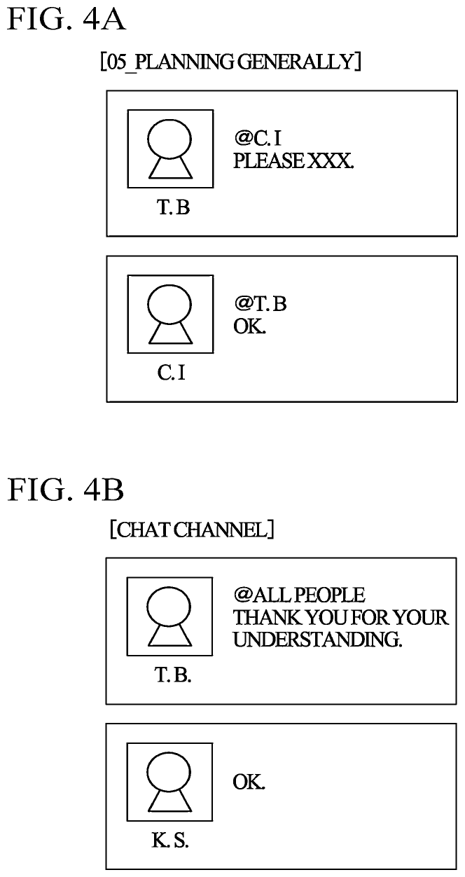

FIG. 4A and FIG. 4b are diagrams showing an example of a conversation in a state in which the user terminal devices 30-1 through 30-n use the chat system provided by the server 20. FIG. 4A and FIG. 4b are diagrams explaining an example of “the number of mentions” described above.

In FIG. 4A, a conversation is shown that is carried out in a channel of “05_Planning generally” provided by the chat system. For example, when a mention, which is made by “T. B” for “C. I” and which designates “C. I” as a destination following an @ sign, arises in the channel of “05_Planning generally,” the first data acquirer 112 counts this mention as one mention of “T. B.” When a mention arises that is made by “C. I” for “T. B” as a response to the mention of “T. B” and that designates “T. B” as a destination following an @ sign, the first data acquirer 112 counts this mention as one mention of “C. I.”

On the other hand, in FIG. 4B, a conversation is shown that is carried out in a channel of a “chat channel” provided by the chat system. For example, when a mention, which is made by “T. B” for all people who participate in the channel of the “chat channel” and which designates all the people who participate in the channel of the “chat channel” as a destination following an @ sign, arises in the channel of the “chat channel,” the first data acquirer 112 counts this mention as mentions of “T. B” for the number of all the people. For example, when 18 people participate in the “chat channel,” the first data acquirer 112 counts this mention as 18 mentions of “T. B.”

As shown in FIG. 4B, when a mention arises that is made by “K. S” as a response to the mention of “T. B” and that has no destination following an @ sign, the first data acquirer 112 does not count this mention.

A way to count the number of mentions described above is an example. A way to count the number of mentions is not limited to the way to count the number of mentions described above. For example, the first data acquirer 112 carries out natural language processing on the content of a mention to perform a determination of one or more persons that receives the mention regardless of whether the mention has a destination with an @ sign. The first data acquirer 112 may count the number of mentions based on a result of the determination.

The number Mᵢ₁ of mentions provided by the person i to the team t₁ may be the number of mentions provided by the person i to the team t₁ within a freely selected period of time. For example, the number of mentions may be the number of mentions provided by the person i to the team t₁ within a period of time after a point in time at which the person i joins the organization A. The period of time after the point in time at which the person i joins the organization A is another example of the first period. Alternatively, the number of mentions may be the number of mentions provided by the person i to the team t₁ within a part of the period of time after the point in time at which the person i joins the organization A. The part of the period of time after the point in time at which the person i joins the organization A is yet another example of the first period.

The first calculator 113 calculates, based on the number of mentions provided by the new member to each of the plurality of teams, a proportion (balance) of the number of mentions provided by the new member to each of the plurality of teams. The proportion of the number of mentions provided by the new member to each of the plurality of teams is an example of a first proportion. As described above, in a state in which the number of mentions provided by the person i that is the new member to the team tⱼ is referred to as Mᵢⱼ, the proportion fᵢⱼ of the number of mentions provided by the person i to the team tⱼ is calculated by the following Formula 1.

$$Formula 1$$

$${f}_{ij} = \frac{{m}_{ij}}{{\sum }_{j = 1}^{m} {m}_{ij}} \qquad [ 1 ]$$

The trained model generator 114 causes a model to learn training data by machine learning to generate the trained model LM1. The model includes multiple coefficients adjustable by machine learning. The training data is representative of a combination of a third proportion and a third indicator value for each member of the members of the organization. The third proportion is a proportion (balance) of the number of mentions provided by a member to each of the plurality of teams. The third indicator value is an indicator value indicative of work engagement representative of a work-related state of mind of the member.

The estimator 115 estimates, based on a relationship between a second proportion and a second indicator value within a period of time before the new member joins the one team, a first indicator value indicative of work engagement of the new member. The period of time before the new member joins the one team is an example of a second period. The second proportion is a proportion (balance) of the number of mentions provided by one member of the members of the organization to each of the plurality of teams within the second period. The second indicator value is an indicator value indicative of work engagement representative of a work-related state of mind of the one member. The estimated first indicator value corresponds to the first proportion of the number of mentions calculated by the first calculator 113. The relationship between the second proportion and the second indicator value may be a relationship between a second proportion and a second indicator value for each of the members.

In particular, it is preferable that the estimator 115 use the trained model LM1 generated by the trained model generator 114 to calculate the first indicator value corresponding to the proportion of the number of mentions provided by the new member to each of the plurality of teams. The trained model LM1 has learned the relationship between the second proportion and the second indicator value.

The second data acquirer 116 acquires, from the analyzer 111, the number of mentions when on a team and the number of mentions when not on the team. The number of mentions when on a team is the number of mentions provided by the new member to one or more members of the team, the team including the new member. The number of mentions when not on the team is the number of mentions provided by the new member to one or more members of one or more teams, the one or more teams not including the new member.

With reference to the example shown in FIG. 3, the second data acquirer 116 acquires Mᵢ₃ as the number of mentions when on a team for the person i that is the new member. The second data acquirer 116 acquires the sum of Mᵢ₁, Mᵢ₂, Mᵢ₄, and Mᵢ₅ as the number of mentions when not on the team for the person i that is the new member.

The second calculator 117 uses the number of mentions when on a team and the number of mentions when not on the team acquired by the second data acquirer 116 to calculate an indicator value indicative of creativity of the new member. Specifically, the second calculator 117 calculates the indicator value indicative of creativity based on the following Formula 2.

$$Formula 2$$

$$CREATIVITY = \frac{NUMBER OF MENTIONS OUT TEAM}{NUMBER OF MENTIONS IN TEAM} \qquad [ 2 ]$$

The third data acquirer 118 acquires, for each mention of the new member, the number of citations and the citation relationship from the analyzer 111. The number of citations is the number of citations from the mention of the new member. The citation relationship indicates a relationship between the new member and one or more members citing the mention of the new member.

The third calculator 119 uses the number of citations and the citation relationship acquired by the third data acquirer 118 to calculate PageRank of the new member as an indicator value indicative of an influence of the new member.

Here, the PageRank is a numerical value calculated by the following Formula 3. In Formula 3, PR (A) means the PageRank of the new member. Tᵢ (i=1, 2 through n) means one or more members citing the mention of the new member. PR (Tᵢ) means PageRank of the one or more members Tᵢ (i=1, 2 through n) citing the mention of the new member. C (Tₙ) means the total number of citations from one or more mentions of one or more members, the one or more members being neither the new member nor the one or more members Tᵢ citing the mention of the new member, the one or more mentions being cited by the one or more members Tᵢ citing the mention of the new member, and d means a damping factor.

$$Formula 3$$

$$PR ( A ) = ( 1 - D ) + d {\sum }_{i = 1}^{n} \frac{PR ( {T}_{i} )}{C ( {T}_{i} )} \qquad [ 3 ]$$

The fourth data acquirer 120 acquires, for each team of the plurality of teams, the numerical value A1 of an external range and the numerical value A2 of degree centrality from the analyzer 111. The numerical value A1 of an external range is the number of members of one or more teams, the one or more teams being other than the team, the members of the one or more teams having had a conversation with one or more members of the team. The numerical value A2 of degree centrality is the number of one or more teams other than the team, the one or more teams including a member having had a conversation with one or more members of the team.

The fourth calculator 121 uses the numerical value A1 of an external range and the numerical value A2 of degree centrality acquired by the fourth data acquirer 120 to calculate at least one of an indicator value indicative of efficiency of a team and an indicator value indicative of a degree of innovation due to the team. Specifically, the fourth calculator 121 calculates the indicator value indicative of efficiency of the team based on the following Formula 4. The fourth calculator 121 calculates the indicator value indicative of a degree of innovation due to the team based on the following Formula 5.

$$Formula 4$$

$$EFFICIENCY = \frac{DEGREE CENTRALITY}{EXTERNAL RANGE} \qquad [ 4 ]$$

$$Formula 5$$

$$INNOVATION = \frac{EXTERNAL RANGE}{DEGREE CENTRALITY} \qquad [ 5 ]$$

The fifth data acquirer 122 acquires, for each organization of the plurality of organizations, the numerical value B1 of an external range and the numerical value B2 of degree centrality from the analyzer 111. The numerical value B1 of an external range is the number of members of one or more organizations, the one or more organizations being other than the organization, the members of the one or more organizations having had a conversation with one or more members of the organization. The numerical value B2 of degree centrality is the number of one or more organizations other than the organization, the one or more organizations including a member having had a conversation with one or more members of the organization.

The fifth calculator 123 uses the numerical value B1 of an external range and the numerical value B2 of degree centrality acquired by the fifth data acquirer 122 to calculate an indicator value indicative of a degree of siloing as a degree of isolation of an organization. Specifically, the fifth calculator 123 calculates the indicator value indicative of a degree of siloing as a degree of isolation of the organization based on the following Formula 6.

$$Formula 6$$

$$SILO = \frac{DEGREE CENTRALITY}{EXTERNAL RANGE} \qquad [ 6 ]$$

Based on the conversation data stored in the server 20, the sixth data acquirer 124 acquires, for each organization of the plurality of organizations, the number of members of the organization having had a conversation with one or more members of a different organization from the organization, as an indicator value indicative of vulnerability against the different organization, from the analyzer 111.

The display controller 125 controls the display 140. For example, the display controller 125 causes the display 140 to display the first indicator value indicative of the work engagement of the new member estimated by the estimator 115. Furthermore, the display controller 125 causes the display 140 to display the indicator value indicative of creativity of the new member calculated by the second calculator 117, for example. Furthermore, the display controller 125 causes the display 140 to display the indicator value indicative of the influence of the new member calculated by the third calculator 119, for example. Furthermore, the display controller 125 causes the display 140 to display at least one of the indicator value indicative of efficiency of a team and the indicator value indicative of a degree of innovation due to a team calculated by the fourth calculator 121, for example. Furthermore, the display controller 125 causes the display 140 to display the indicator value indicative of a degree of siloing as a degree of isolation of an organization calculated by the fifth calculator 123, for example. Furthermore, the display controller 125 causes the display 140 to display the indicator value indicative of vulnerability against a different organization acquired by the sixth data acquirer 124, for example.

As will be described below, these values may be displayed by at least one of the user terminal devices 30-1 through 30-n. In this case, the ability evaluating apparatus 10 may not necessarily include the display controller 125 and the display 140. Examples of images displayed by the display controller 125 on the display 140 will be described below with reference to FIG. 15 through FIG. 26.

### 1.3 Configuration of Server

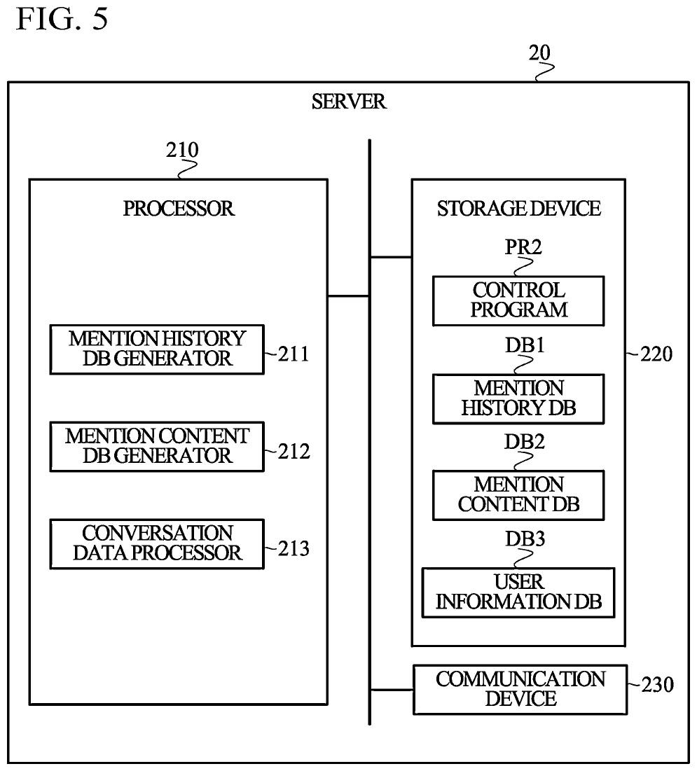

FIG. 5 is a block diagram showing an example of a configuration of the server 20. The server 20 includes a processor 210, a storage device 220, and a communication device 230. Each element of the server 20 is interconnected by a single bus or by multiple buses for communicating information.

The processor 210 is a processor configured to control the entire server 20. The processor 210 is constituted of a single chip or of multiple chips, for example. The processor 210 is constituted of a central processing unit including, for example, interfaces for peripheral devices, arithmetic units, registers, etc. One, some, or all of the functions of the processor 210 may be implemented by hardware such as a DSP, an ASIC, a PLD, and an FPGA. The processor 210 executes various processing in parallel or sequentially.

The storage device 220 is a recording medium readable and writable by the processor 210. The storage device 220 stores a plurality of programs including a control program PR2 to be executed by the processor 110, the conversation data used in the chat system provided by the server 20, a mention history database DB1, a mention content database DB2, and a user information database DB3. Here, the mention history database DB1 is generated by a mention history database generator 211 described below based on the conversation data described above. The mention content database DB2 is generated by a mention content database generator 212 described below based on the conversation data described above. The user information database DB3 is a database of user information of the chat system described above. The storage device 220 may be constituted of, for example, at least one of a ROM, an EPROM, an EEPROM, a RAM, etc. The storage device 220 may be referred to as a register, a cache, a main memory, or a main storage, etc.

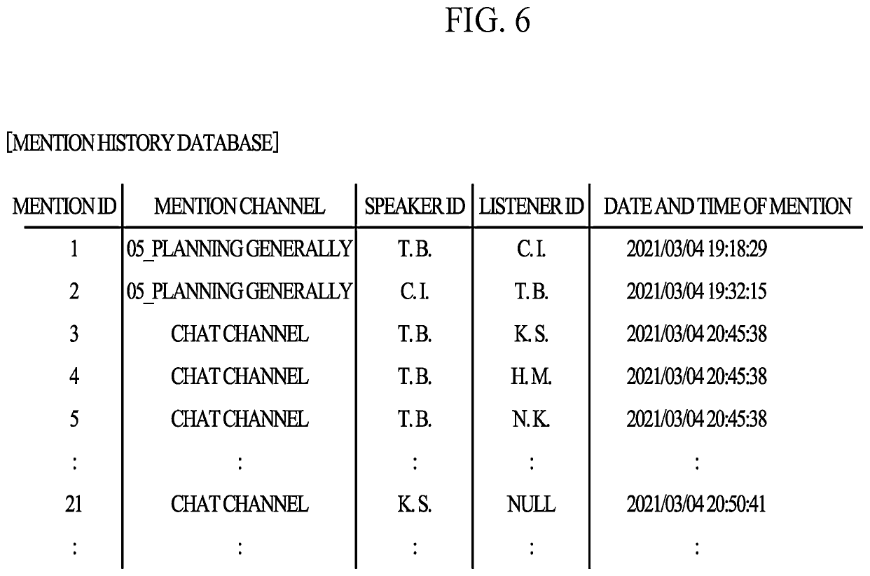

In FIG. 6, an example of a configuration of the mention history database DB1 is shown. The mention history database DB1 is a database configured to store, for each mention, a mention channel in which the mention is carried out, an ID of a speaker that makes the mention, an ID of a listener that receives the mention, and data related to a date and time of the mention, together with an ID of the mention.

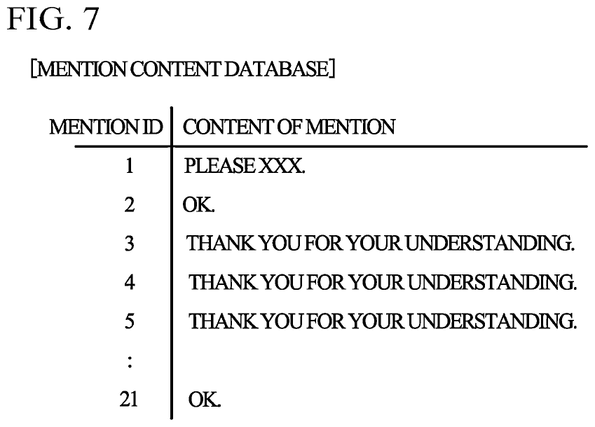

In FIG. 7, an example of a configuration of the mention content database DB2 is shown. The mention content database DB2 is a database configured to store, for each mention, the content of the mention together with an ID of the mention.

The examples of data shown in FIG. 6 and FIG. 7 correspond to the examples of the conversations in the chat system shown in FIG. 4A and FIG. 4B. In other words, among a plurality of pieces of data shown in FIG. 6 and FIG. 7, a mention with a mention ID=1 corresponds to the mention from “T. B” to “C. I” shown in FIG. 4A. A mention with a mention ID=2 corresponds to the mention from “C. I” to “T. B” shown in FIG. 4A. Mentions with mention IDs=3 through 5 correspond to the mentions from “T. B” to “all people” shown in FIG. 4B. A mention with a mention ID=21 corresponds to the mention from “Mr. K.S” to no destinations shown in the FIG. 4B.

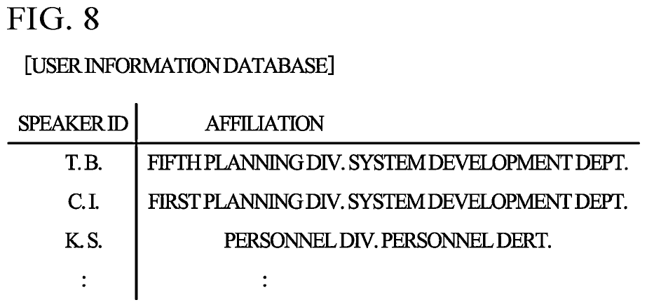

In FIG. 8, an example of a configuration of the user information database DB3 is shown. The user information database DB3 is a database configured to store a relationship between IDs of speakers and affiliations of the speakers.

The communication device 230 is a transmitting and receiving device configured to communicate with other devices. The transmitting and receiving device is hardware. For example, the communication device 230 may be referred to as a network device, a network controller, a network card, a communication module, etc. The communication device 230 may include a connector for wired connection and an interface circuit corresponding to the connector for wired connection. The communication device 230 may include a wireless communication interface. The connector for wired connection and interface circuit may conform to wired LAN, IEEE1394, or USB. The wireless communication interface may conform to wireless LAN or Bluetooth (registered trademark), etc.

The processor 210 reads the control program PR2 from the storage device 220. The processor 210 executes the control program PR2 to function as the mention history database generator 211, the mention content database generator 212, and a conversation data processor 213. The control program PR2 may be transmitted from another device, such as a server configured to manage the ability evaluating apparatus 10, to the server 20 via the communication network NET.

The mention history database generator 211 generates the mention history database DB1 based on mention data input from the respective user terminal devices 30-1 through 30-n via the communication device 230.

The mention content database generator 212 generates the mention content database DB2 based on the mention data input from the respective user terminal devices 30-1 through 30-n via the communication device 230.

The conversation data processor 213 generates the conversation data based on the mention history database DB1, on the mention content database DB2, and on the user information database DB3. The conversation data processor 213 outputs the conversation data to the respective user terminal devices 30-1 through 30-n via the communication device 230.

In particular, upon receipt of the data request Rq1 from the ability evaluating apparatus 10, the conversation data processor 213 generates conversation data within the period D1 from conversation data of the new member on the basis of the ID of the new member and the period D1 for conversation data specified by the data request Rq1. Then, the conversation data processor 213 outputs the generated conversation data of the new member within the period D1 to the ability evaluating apparatus 10 via the communication device 230.

Furthermore, upon receipt of the data request Rq2 from the ability evaluating apparatus 10, the conversation data processor 213 generates conversation data within the period D2 from the conversation data on the basis of the period D2 for conversation data specified by the data request Rq2. Then, the conversation data processor 213 outputs the generated conversation data within the period D2 to the ability evaluating apparatus 10 via the communication device 230.

Here, “mention data” is data about a mention provided by a member of an organization to one or more members. The mention data is data about a single mention provided in one direction. On the other hand, “conversation data” is an accumulation of “mention data.” The conversation data may include data about a single mention provided in one direction, or may include data about a plurality of mentions provided in two directions among multiple members.

In FIG. 5, the server 20 includes neither a display nor an input device. However, the server 20 may include a display and an input device.

### 1.4 Configuration of User Terminal Device

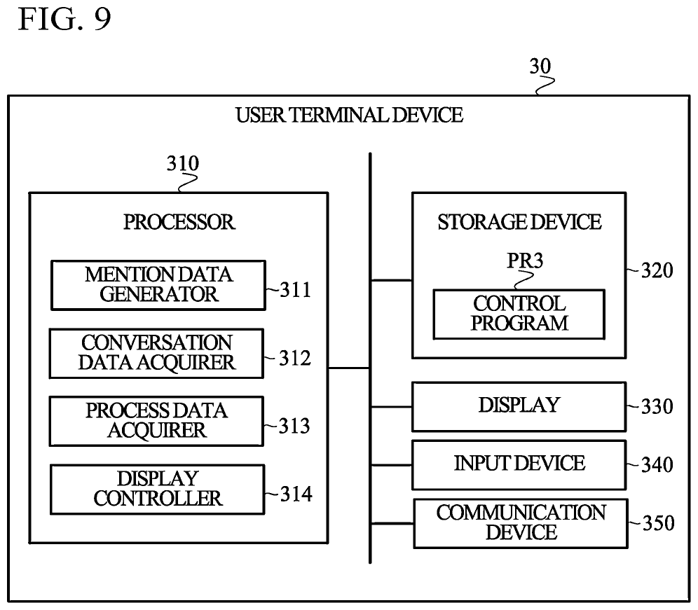

FIG. 9 is a block diagram showing an example of a configuration of the user terminal device 30. The user terminal device 30 may typically be a PC. However, the user terminal device 30 is not limited to a PC, and it may be a tablet terminal or a smartphone, for example. The user terminal device 30 includes a processor 310, a storage device 320, a display 330, an input device 340, and a communication device 350. Each element of the user terminal device 30 is interconnected by a single bus or by multiple buses for communicating information.

The processor 310 is a processor configured to control the entire user terminal device 30. The processor 310 is constituted of a single chip or of multiple chips, for example. The processor 310 is constituted of a central processing unit including, for example, interfaces for peripheral devices, arithmetic units, registers, etc. One, some, or all of the functions of the processor 310 may be implemented by hardware such as a DSP, an ASIC, a PLD or an FPGA. The processor 310 executes various processing in parallel or sequentially.

The storage device 320 is a recording medium readable and writable by the processor 310. The storage device 320 stores a plurality of programs including a control program PR3 to be executed by the processor 310, the mention data, the conversation data, and data about the work indicator value. Here, the mention data described above is data generated by a mention data generator 311 described below. The conversation data described above is data acquired by a conversation data acquirer 312 described below. The data about work indicator value described above is data acquired by a process data acquirer 313 described below. The storage device 320 may be constituted of, for example, at least one of a ROM, an EPROM, an EEPROM, a RAM, etc. The storage device 320 may be referred to as a register, a cache, a main memory, or a main storage, etc.

The display 330 is a device configured to display images and character information. The display 330 displays various images under control executed by the processor 310. For example, various display panels, such as liquid crystal display panels, and organic electroluminescent (EL) display panels, are suitably used as the display 330.

The input device 340 is a device configured to receive an operation made by a user. For example, the input device 340 includes a keyboard and a pointing device such as a touch pad, a touch panel, or a mouse. Here, the input device 340, which includes a touch panel, may serve as the display 330.

The communication device 350 is a transmitting and receiving device configured to communicate with other devices. The transmitting and receiving device is hardware. For example, the communication device 350 may be referred to as a network device, a network controller, a network card, a communication module, etc. The communication device 350 may include a connector for wired connection and an interface circuit corresponding to the connector for wired connection. The communication device 350 may include a wireless communication interface. The connector for wired connection and interface circuit may conform to wired LAN, IEEE1394, or USB. The wireless communication interface may conform to wireless LAN or Bluetooth (registered trademark), etc.

The processor 310 reads the control program PR3 from the storage device 320. The processor 310 executes the control program PR3 to function as the mention data generator 311, the conversation data acquirer 312, the process data acquirer 313, and a display controller 314. The control program PR3 may be transmitted from another device, such as a server configured to manage the ability evaluating apparatus 10, to the user terminal device 30 via the communication network NET.

The mention data generator 311 generates the mention data based on the content of input from a member of the organization that uses the input device 340 of the user terminal device 30. The mention data generator 311 outputs the generated mention data to the server 20 via the communication device 350. Furthermore, the mention data generator 311 stores the generated mention data in the storage device 320.

The conversation data acquirer 312 acquires the conversation data from the server 20 via the communication device 350. The conversation data acquirer 312 stores the acquired conversation data in the storage device 320.

The process data acquirer 313 acquires data, which is generated by the ability evaluating apparatus 10, from the ability evaluating apparatus 10 via the communication device 350. More specifically, the process data acquirer 313 acquires, as the data generated by the ability evaluating apparatus 10, the indicator value indicative of work engagement, the indicator value indicative of creativity, the indicator value indicative of influence, the indicator value indicative of efficiency of team, the indicator value indicative of a degree of innovation due to team, the indicator value indicative of a degree of siloing as a degree of isolation of an organization, and an indicator value indicative of vulnerability against a different organization for each organization, which are described. The data generated by the ability evaluating apparatus 10 is not limited to these data.

The display controller 314 controls the display 330. For example, the display controller 314 causes the display 330 to display the mention data generated by the mention data generator 311. Furthermore, the display controller 314 causes the display 330 to display the conversation data acquired by the conversation data acquirer 312, for example. Furthermore, the display controller 314 causes the display 330 to display the process data generated by the ability evaluating apparatus 10, the process data generated by the ability evaluating apparatus 10 being acquired by the process data acquirer 313, for example.

As described above, with the ability evaluating apparatus 10 including the display controller 125 and the display 140, the display controller 125 may cause the display 140 to display the process data generated by the ability evaluating apparatus 10.

### 2. Operation of Embodiment

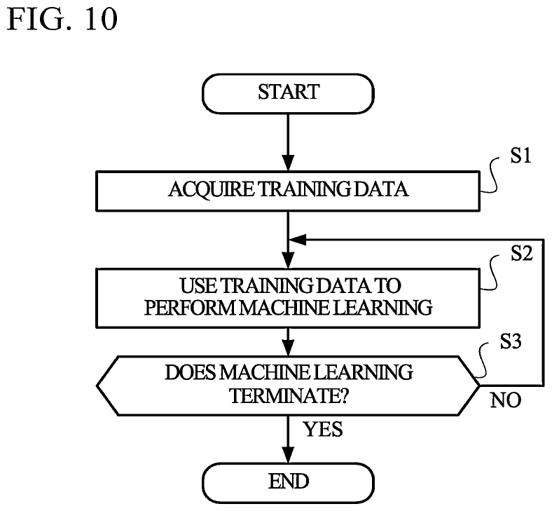

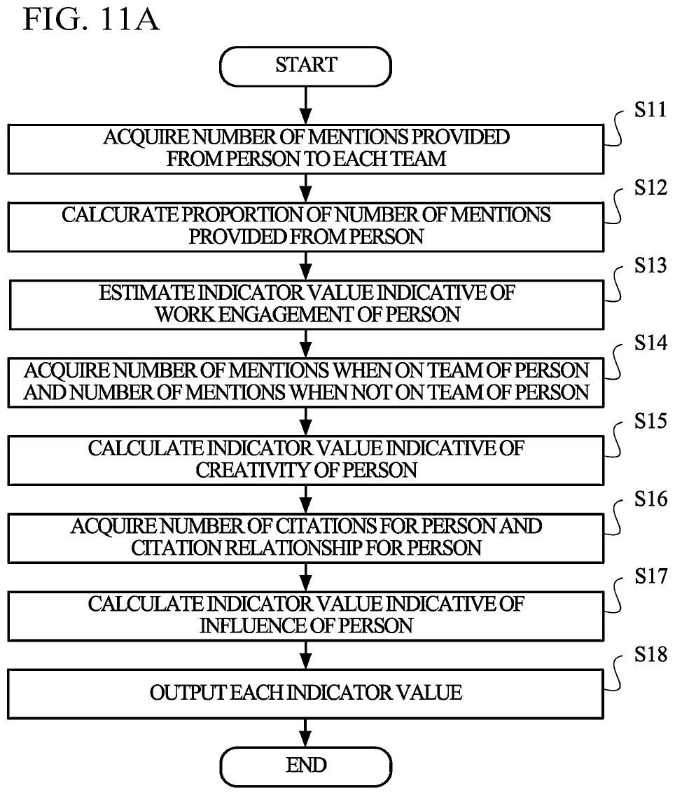

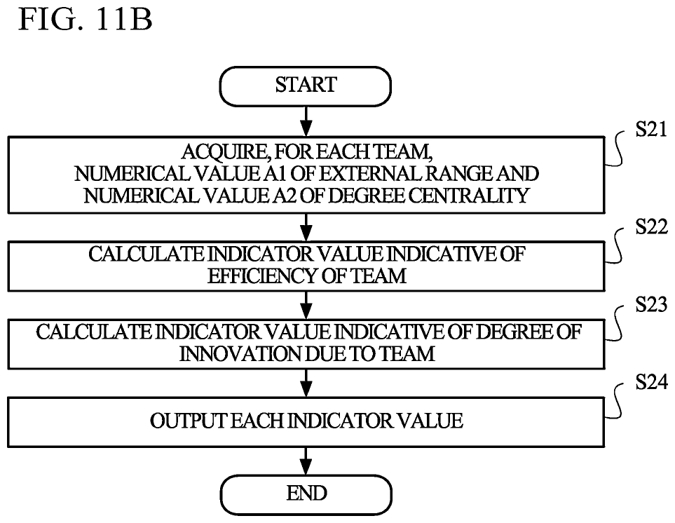

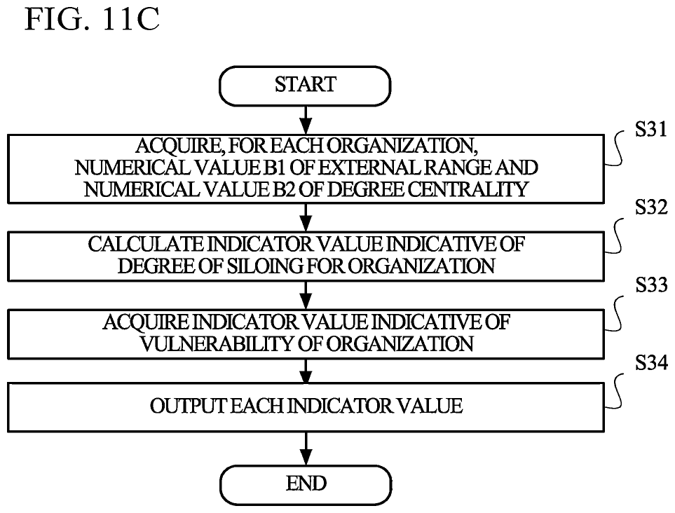

Next, an operation of the ability evaluating apparatus 10 according to the present embodiment will be described with reference to FIG. 10 through FIG. 11C. FIG. 10 is a flowchart showing an operation of the ability evaluating apparatus 10 during machine learning. FIG. 11A through FIG. 11C are flowcharts showing an operation of the ability evaluating apparatus 10 during use. More particularly, FIG. 11A is a flowchart showing an operation of the ability evaluating apparatus 10 to output an indicator value related to work for each of the members of the organization. FIG. 11B is a flowchart showing an operation showing an operation of the ability evaluating apparatus 10 to output an indicator value related to work for each of the plurality of teams. FIG. 11C is a flowchart showing an operation of the ability evaluating apparatus 10 to output an indicator value related to work for each of the organizations.

### 2.1 Operation During Machine Learning

At step S1 in FIG. 10, the trained model generator 114 acquires the training data. The training data indicates, for each member of the organization, a combination of a proportion of the number of mentions provided by the member to each of the plurality of teams and an indicator value indicative of work engagement of the member.

At step S2, the trained model generator 114 causes a training model to learn, by machine learning, the acquired training data.

At step S3, when the machine learning terminates (S3: YES), processing shown in FIG. 10 terminates. In response to the termination of the machine learning, the trained model generator 114 completes the generation of the trained model LM1. The trained model LM1 is trained to learn a relationship between a proportion of the number of mentions provided by one member of the members of the organization to each of the plurality of teams and an indicator value indicative of work engagement of the one member. In a state in which the machine learning has not yet terminated (S3: NO), the processing returns to step S2.

### 2.2 Operation During Use

### 2.2.1 Operation to Output an Indicator Value for Each of the Members of the Organization

At step S11 in FIG. 11A, the first data acquirer 112 acquires the number of mentions provided by a person, who is the new member, to each of the plurality of teams within a period of time after the person joins one team of the teams.

At step S12, the first calculator 113 calculates, based on the number of mentions provided by the new member to each of the plurality of teams acquired by the first data acquirer 112, the proportion (balance) of the number of mentions provided by the new member to each of the plurality of teams.

At step S13, the estimator 115 inputs, into the trained model LM1 generated by the trained model generator 114, the proportion of the number of mentions provided by the new member to each of the plurality of teams calculated by the first calculator 113. The estimator 115 estimates, as an indicator value indicative of work engagement of the new member, an indicator value output from the trained model LM1 responsive to the input of the proportion of the number of mentions provided by the new member to each of the plurality of teams.

At step S14, the second data acquirer 116 acquires the number of mentions when on a team and the number of mentions when not on the team. The number of mentions when on a team is the number of mentions provided by the new member to one or more members of the team, the team including the new member. The number of mentions when not on the team is the number of mentions provided by the new member to one or more members of one or more teams, the one or more teams not including the new member.

At step S15, the second calculator 117 uses the number of mentions when on a team and the number of mentions when not on the team acquired by the second data acquirer 116 to calculate the indicator value indicative of creativity of the new member.

At step S16, the third data acquirer 118 acquires, for each mention of the new member, the number of citations and the citation relationship. The number of citations is the number of citations from a mention of the new member. The citation relationship indicates a relationship between the new member and one or more members citing the mention of the new member.

At step S17, the third calculator 119 uses the number of citations and the citation relationship acquired by the third data acquirer 118 to calculate the PageRank of the new member as an indicator value indicative of the individual influence of the new member.

At step S18, the communication device 160 outputs the indicator value indicative of the work engagement of the person, the indicator value indicative of creativity of the person, and the indicator value indicative of the influence of the person, to at least one user terminal device 30 among the user terminal devices 30-1 through 30-n. The ability evaluating apparatus 10 then terminates all processing shown in FIG. 11A.

### 2.2.2 Operation to Output an Indicator Value for Each Team of the Plurality of Teams

At step S21 in the FIG. 11B, the fourth data acquirer 120 acquires, for each team of the plurality of teams, the numerical value A1 of an external range and the numerical value A2 of degree centrality. The numerical value A1 of an external range is the number of members of one or more teams, the one or more teams being other than the team, the members of the one or more teams having had a conversation with one or more members of the team. The numerical value A2 of degree centrality is the number of one or more teams other than the team, the one or more teams including a member having had a conversation with one or more members of the team.

At step S22, the fourth calculator 121 uses the numerical value A1 of an external range and the numerical value A2 of degree centrality acquired by the fourth data acquirer 120 to calculate the indicator value indicative of efficiency of the team.

At step S23, the fourth calculator 121 uses the numerical value A1 of an external range and the numerical value A2 of degree centrality acquired by the fourth data acquirer 120 to calculate the indicator value indicative of a degree of innovation due to the team.

At step S24, the communication device 160 outputs at least one of the indicator value indicative of efficiency of the team and the indicator value indicative of a degree of innovation due to the team, to at least one user terminal device 30 among the user terminal devices 30-1 through 30-n. The ability evaluating apparatus 10 then terminates all processing shown in FIG. 11B.

### 2.2.3 Operation to Output an Indicator Value for Each Organization of the Organizations

At step S31 in FIG. 11C, the fifth data acquirer 122 acquires, for each organization of the organizations, the numerical value B1 of an external range and the numerical value B1 of degree centrality. The numerical value B1 of an external range is the number of members of one or more organizations, the one or more organizations being other than the organization, the members of the one or more organizations having had a conversation with one or more members of the organization. The numerical value B2 of degree centrality is the number of one or more organizations other than the organization, the one or more organizations including a member having had a conversation with one or more members of the organization.

At step S32, the fifth calculator 123 uses the numerical value B1 of an external range and the numerical value B2 of degree centrality acquired by the fifth data acquirer 122 to calculate the indicator value indicative of a degree of siloing as a degree of isolation of an organization.

At step S33, the sixth data acquirer 124 acquires, for each organization of the organizations, the number of members of the organization having had a conversation with one or more members of a different organization from the organization, as an indicator value indicative of vulnerability against the different organization.

At step S34, the communication device 160 outputs at least one of the indicator value indicative of a degree of siloing for each of the organizations and the indicator value indicative of vulnerability against one or more different organizations for each of the organizations, to at least one user terminal device 30 among the user terminal devices 30-1 through 30-n. Then, all processing terminates.

### 3. Application Examples

### 3.1 Examples of a Method of Machine Learning

First, the concept of “work engagement” described above will be described, then an example of a method of machine learning described above will be described.

The Covid-19 pandemic has explosively engulfed the world and as a result, a new way of life referred to as the “New Normal,” which includes a shift from the traditional office-based work style to a more remote work style, is spreading rapidly. However, the amount of in-person communication decreases in a remote work setting; accordingly, it is difficult for managers to understand the level of engagement of a subordinate. Here, the level of “work engagement” is defined as the summation of absorption, dedication and vigour [for example, “Wilmar B. Schaufeli, Marisa Salanova, Vicente Gonzalez-Roma, and Arnold B. Bakker. 2002. The measurement of engagement and burnout: A two sample conenterpriseatory factor analytic approach. Journal of Happiness Studies 3, 1 (2002”), 71-92]. Employee work engagement influences the business performance of a company. Specifically, a decrease in the level of employee work engagement causes a downturn in business. Therefore, it is crucial for a company to recognize this situation and maintain the level of employee work engagement.

To obtain the level of work engagement, as will be described below, it is possible to estimate a work engagement level of a speaker using text-based communication tools, such as Slack (registered trademark) and Microsoft Teams (registered trademark), without using questionnaires or the content of chat tool text. Specifically, a work engagement level of a speaker can be estimated only by knowing a person in conversation with the speaker and an affiliation department of the speaker. It is considered that work engagement propagates through communications via a chat tool. In other words, work engagement is strongly influenced by the frequency of conversations between a speaker and a person in conversation with the speaker. According to this idea, Applicant established a trained model to estimate work engagement of a speaker based on a person in conversation with the speaker and an affiliation department of the speaker, and used this trained model to perform evaluations based on actual data from Slack. The results reveal that work engagement of a speaker is more greatly influenced by a team in conversation with the speaker and the frequency of conversations than by the content of the chat. Due to a correlation coefficient between a true value and a predicted value of 0.72, a work engagement level of a speaker can be estimated without either a need for a questionnaire required to calculate the work engagement of the speaker or a need for a confidential content of answers to the questionnaire.

An example of developing the trained model is described below. Applicant developed, as the trained model described above, a trained model configured to estimate a work engagement level of a speaker from data from Slack that is a text-based communication tool. To train the model, text data from data of Slack used by members of the development department of NTT DOCOMO, INC., was used with their consent. Slack contains two team layers. The first layer is called a workspace, which contains all department members. The second layer is called a channel, which contains project-based members, and includes a private channel, which is a permission-based channel that requires permission to access the private channel, and a public channel allowed to be viewed by all members of the workspace. Thus, there is little concern for privacy in the public channel. To develop the trained model, all public channel data was extracted. The data contains text, a speaker, and a conversation partner. There is a chat mention marker such as @[user name] in each text. The number of mentions of each user was counted using this marker. If there are no markers in the text, it was determined that a speaker was in conversation with all users in the channel.

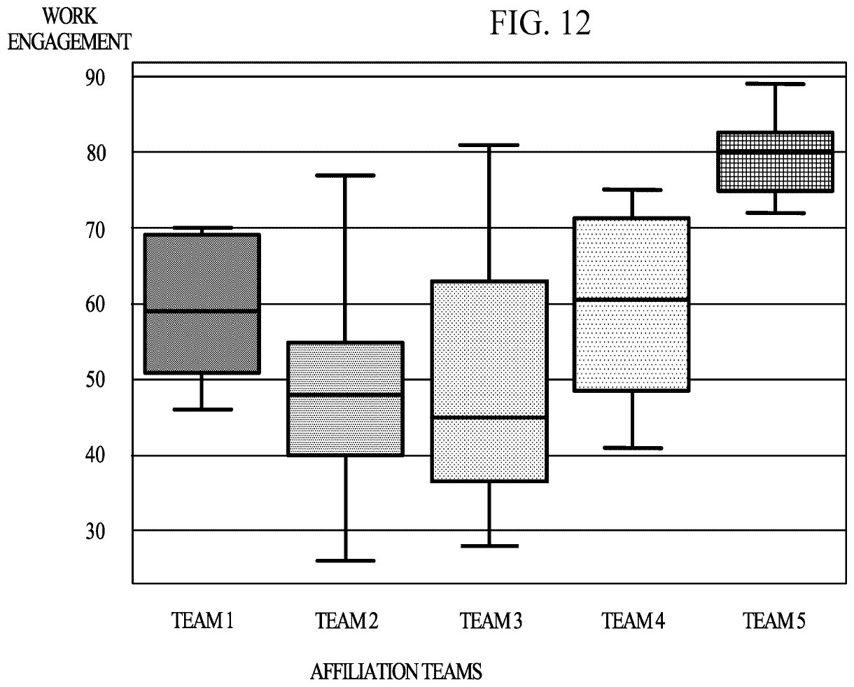

There are five teams in the development department, team 1 through team 5. Teams 1, 2, 3, 4, and 5 have six, six, three, six, and seven subjects, respectively. The work engagement score, an objective variable of the trained model, was measured for 28 subjects using a questionnaire method. In FIG. 12, a box plot of a work engagement level for each team is shown. For example, the work engagement level for team 5 is concentrated at a high level. The work engagement levels of team 2 and team 3 are distributed from a low level to a high level.

As described above, it is considered that work engagement propagates through chat tools. In other words, a work engagement level of a speaker changes by the speaker making conversation with a team with high work engagement or with low work engagement. Applicant considers that the content of conversation with a speaker does not influence a work engagement level of the speaker as strongly as a person in conversation with the speaker. On the other hand, some research indicates that a manner in which a speaker uses language is an essential factor in evaluating the speaker's personality. Applicant considered two features: a frequency feature representative of the frequency of conversations for each team; and a content feature representative of the content of a chat. The results reveal that the evaluation of the work engagement statistically depends more strongly on the frequency feature than on the content feature.

A feature value related to the frequency feature is calculated by the following Formula 7.

$$Formula 7$$

$$FREQUENCY FEATURE = \frac{NUMBER OF MENTIONS TO TEAMi}{\begin{matrix}NUMBER OF MENTIONS TO \\ RESPECTIVE TEAMS OF ALL TEAMS\end{matrix}} i = 1 through 5 \qquad [ 7 ]$$

Here, the number of mentions to team i is the total number of mentions provided by a speaker to members of team i. As described above, a chat mention, in other words, a person in conversation with the speaker, is recognized by use for the marker “@[user name]” used in the chat tool.

In contrast, Applicant used word embedding based on a BERT, a natural language processing model, as a way to acquire a feature value related to the content feature. Applicant gathered all posts, split all the posts into morphemes (words), represented the words as 500 dimension embedding vectors, and took sample averages for each user based on the 500 dimension embedding vectors. The language in the considered text data is Japanese; accordingly, raw text should be split into morphemes. Thus, Applicant used a JUMAN, which is a Japanese morphological analysis system, to split the text into words by using word classes including only noun, verb, adjective, and adverb.

Next, a feature value, which significantly influences work engagement, will be described based on mutual information. Mutual information between two random variables is a non-negative value, which is used to measure statistical independence between those variables. Only if the two random variables are independent of each other, the mutual information is equal to zero. The greater the mutual information, the greater the interdependence of the random variables. Applicant estimated the mutual information of all pairs of the above features and work engagement using non-parametric methods based on entropy estimation from a k-nearest neighbor distance.

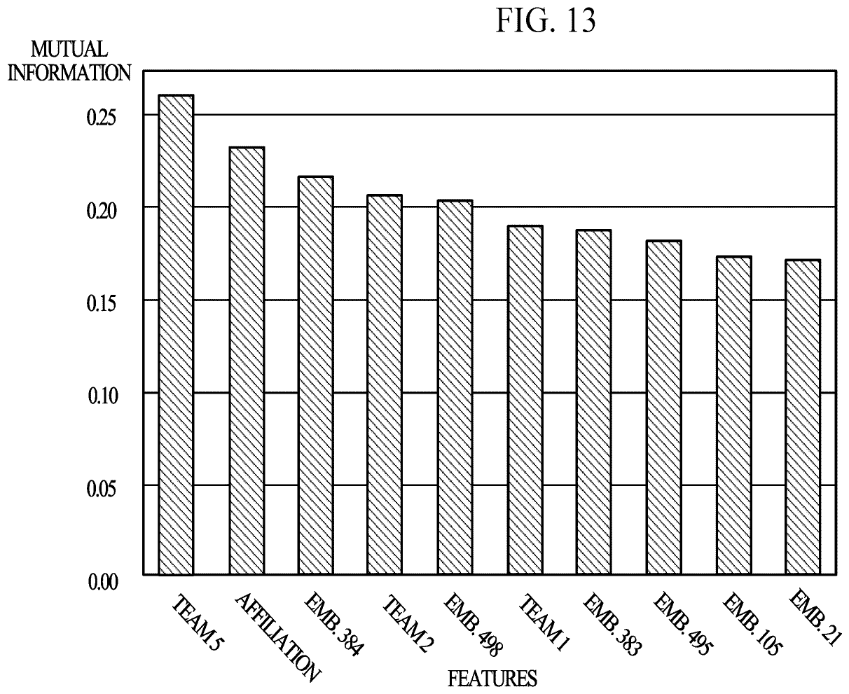

FIG. 13 is a graph of values of the mutual information between each feature and work engagement. Furthermore, FIG. 13 is a graph of features from a feature having the highest mutual information to a feature having the 10th highest mutual information, in descending order of the features. For example, “team 5” in a horizontal axis in FIG. 13 means the dependence of work engagement of a speaker on the frequency of conversations between the speaker and a member of team 5. In addition, “affiliation” means the dependency of the work engagement of the speaker on an affiliation department of the speaker. In addition, “emb” indicates the dependency of the work engagement of the speaker on a particular word embedded in a mention of the speaker. A number following “emb” means an identifier of a word embedded in the mention.

According to FIG. 13, the work engagement of the speaker is most dependent on the feature of team 5, in other words, on the frequency of conversations between the speaker and team 5. The second most dependent feature is the affiliation department of the speaker. Thus, it will be apparent that the work engagement of the speaker strongly depends on the person in conversation with the speaker and on the affiliation department of the speaker. In addition, features due to the embedding of words are rarely found, in FIG. 13. Specifically, regarding the features due to the embedding of words, only (6/500*100)%=1.2% of all the embedded words are included within the top 10 levels of the mutual information. On the other hand, regarding features related to the frequency of conversations, (3/5*100)%=60% of all the teams are included within the top 10 levels of the mutual information. Thus, it is apparent that the work engagement of the speaker more strongly depends not only on elements, which include a person in conversation with the speaker and the frequency of conversations between the speaker and the person in conversation with the speaker, but also on an element that includes an affiliation department of the speaker, than the content of conversation with the speaker.

Based on the analysis described above, Applicant developed a regression model for work engagement of a speaker, the regression model using features representative of a person in conversation with the speaker and of an affiliation team of the speaker. Specifically, feature xi (i=1, 2 through 5) is defined by Formula 2 described above, and feature x6 is the team number of the affiliation team of the speaker. These features were calculated based both on a degree of mentions in chats and on the amount of data from Slack, the degree of mentions in the chats being based on the marker “@[user name].” To the regression model, LightGBM was applied.

To evaluate the above trained model, Applicant calculated a correlation coefficient between a predicted value of work engagement and a true value of work engagement. For the 28 subjects contained in the Slack dataset described above, the model using features x1 through x6 estimated work engagement. Applicant then performed cross validation regarding the above trained model and baseline models to compare the trained model with the baseline models. The first baseline model used the content feature, and the second baseline model used both the content feature and the frequency feature.

The details of the cross validation will be described below. First, one subject was selected for test data. Then, the reserved dataset was split into a training set and a testing set based on the ratio of eight to two. Machine learning was performed by LightGBM using the training set. Then, hyperparameters on the testing set were tuned by Optuna (registered trademark) for optimizing the hyperparameters using a Tree-structured Parzen Estimator.

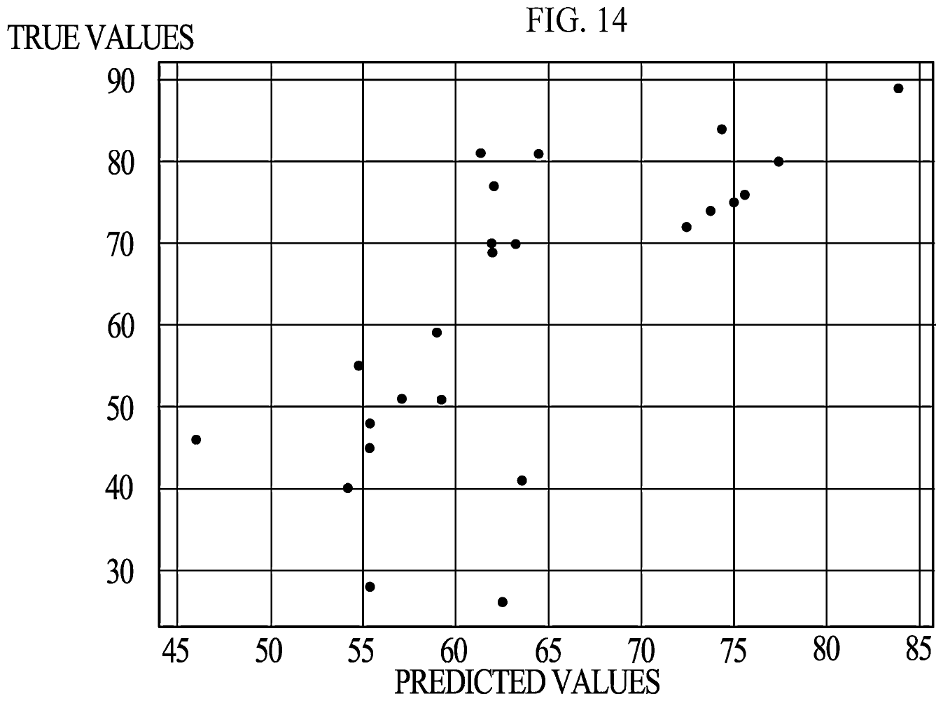

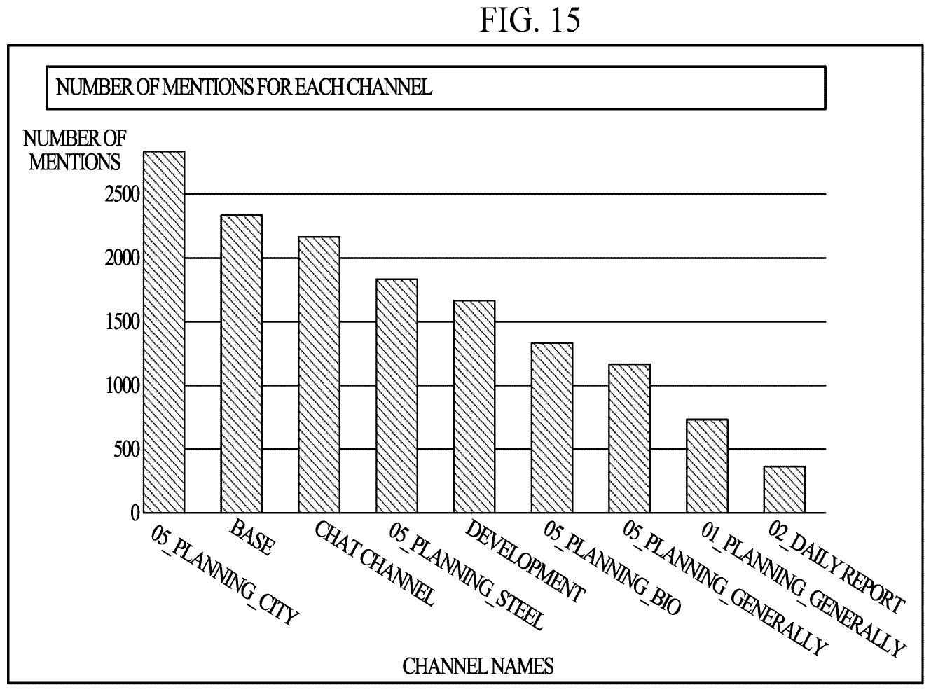

In FIG. 14 and Table 1, the results of the validation are shown. More particularly, FIG. 14 is a graph of the relationship between predicted values and true values with the trained model according to the present invention being used. Table 1 shows a correlation coefficient between a predicted value and a true value for each model. As shown in Table 1, the Pearson correlation coefficient is 0.72 when an only frequency feature is used. Thus, it will be apparent that the trained model according to the present invention can sufficiently estimate a value of work engagement of a speaker without using the content feature in a chat tool. In addition, the p-value of a statistical hypothesis test is 1.1*10⁻⁵ when the correlation coefficient between the predicted value of work engagement and the true value of work engagement is zero. On the other hand, the first baseline model using only the content feature yields the worst performance compared to other models that use different features. More specifically, when the baseline model using only the content feature is used, a correlation coefficient between a predicted value of work engagement of a speaker and a true value of work engagement of the speaker is −0.05. In other words, the first baseline model using only the content feature cannot estimate the work engagement of the speaker. When the second baseline model using both the content feature and the frequency feature is used, a correlation coefficient between a predicted value of work engagement of a speaker and a true value of work engagement of the speaker is 0.55. These results reveal that a value of work engagement of a member is estimated by the frequency of conversations with a team including a member with a high work engagement level. In other words, the work engagement propagates through text-based communications.

TABLE 1

| | FEATURE | | |
|---|---|---|---|
| | | | CONTENT |
| | WORD | FREQUENCY | FEATURE AND |
| | EMBEDDING | FEATURE | FREQUENCY |
| | (BERT) | (x1, . . . , x6) | FEATURE |
| CORRELATION | −0.05 | 0.72 | 0.55 |
| COEFFICIENT | | | |

As described above, mutual information between work engagement of a speaker and the frequency of conversations between the speaker and each team member is compared with mutual information between the work engagement of the speaker and the content of conversation with the speaker; as a result, it becomes clear that work engagement of a speaker is more strongly influenced by an affiliation department of the speaker and the frequency of conversation with the speaker than the content of conversation with the speaker. Considering these results, Applicant developed the regression model configured to estimate work engagement of a speaker using a text-based chat tool. This model does not need the content of conversation with the speaker, and only uses the affiliation department of the speaker and the frequency of conversations with the speaker. Thus, this regression model does not require confidential data related to the content of conversation in a chat tool, as a feature used for generating the regression model. It was shown that the trained model according to the present invention estimated work engagement of a speaker at a correlation coefficient of 0.72. This result shows that the trained model according to the present invention is able to sufficiently estimate work engagement of a speaker only using data indicative of a team having conversation with the speaker and of the frequency of conversations between the team and the speaker. In other words, it becomes clear that work engagement propagates through text-based chat tools and is influenced by the frequency of conversations with other team members.

As described above, the trained model generator 114 causes a learner to perform machine learning using, for example, LightGBM to generate the trained model configured to calculate the work engagement of the new member corresponding to the proportion of the number of mentions provided by the new member to each of the plurality of teams. However, a method of generating the trained model is not limited to this method. For example, instead of LightGBM, other machine learning techniques such as an XGboost, a random forest, and a support vector machine may be used.

### 3.2 Examples of Display Screens

As described above, the display 140 provided in the ability evaluating apparatus 10 or the display 330 provided in the user terminal device 30 displays the process data generated by the ability evaluating apparatus 10. In FIG. 15 through FIG. 26, examples of images representative of the process data are shown.

The display controller 125 may cause the display 140 to display the number of mentions for each channel, as shown in FIG. 15, based on the content of input from the input device 150. Similarly, the display controller 314 may cause the display 330 to display the number of mentions for each channel, as shown in FIG. 15, based on the content of input from the input device 340.

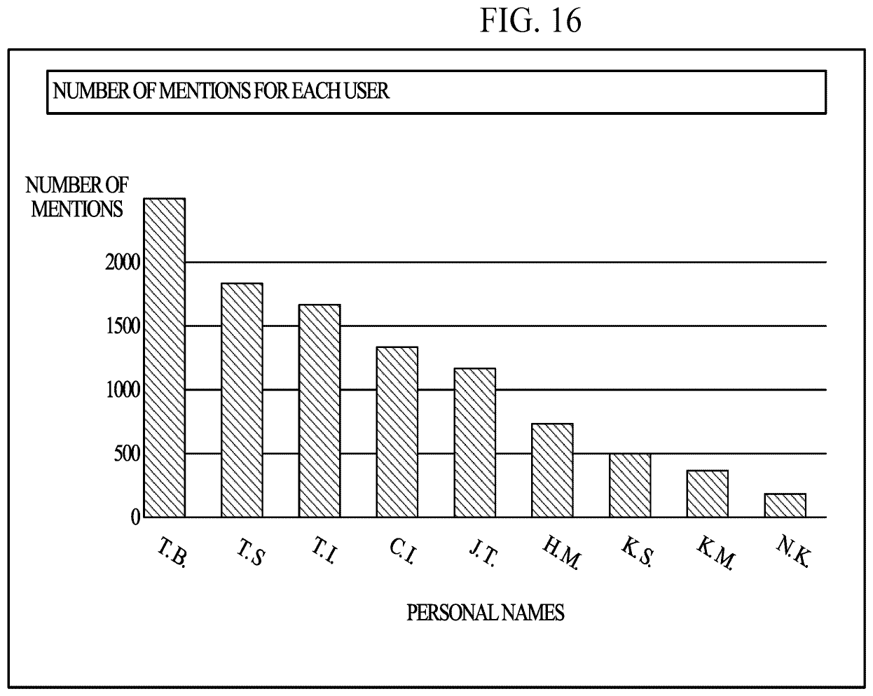

The display controller 125 may cause the display 140 to display the number of mentions for each user, as shown in FIG. 16, based on the content of input from the input device 150. Similarly, the display controller 314 may cause the display 330 to display the number of mentions for each user, as shown in FIG. 16, based on the content of input from the input device 340.

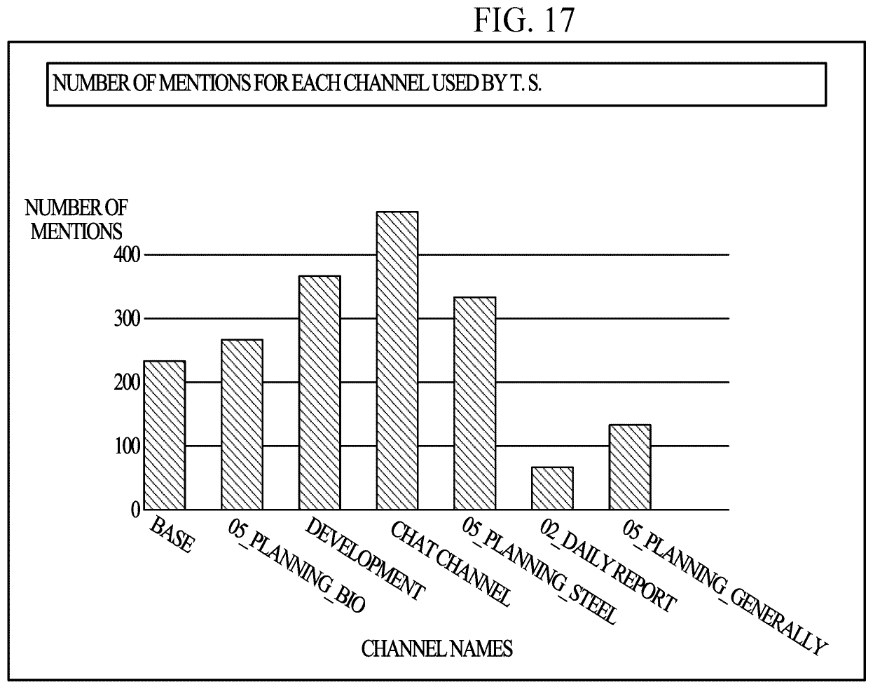

The display controller 125 may cause the display 140 to display the number of mentions for each channel used by a particular user, as shown in FIG. 17, based on the content of input from the input device 150. Similarly, the display controller 314 may cause the display 330 to display the number of mentions for each channel used by a particular user, as shown in FIG. 17, based on the content of input from the input device 340.

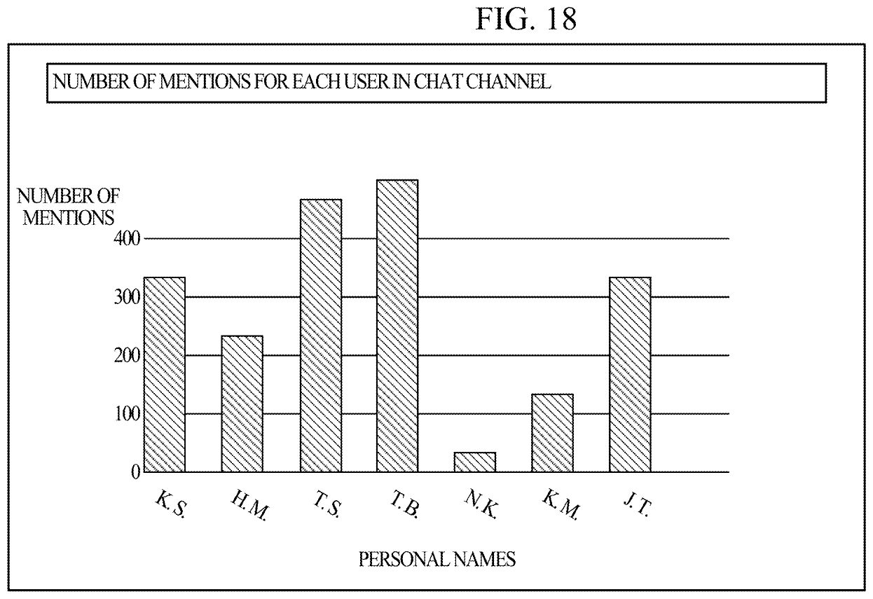

The display controller 125 may cause the display 140 to display the number of mentions for each user in a particular channel, as shown in FIG. 18, based on the content of input from the input device 150. Similarly, the display controller 314 may cause the display 330 to display the number of mentions for each user in a particular channel, as shown in FIG. 18, based on the content of input from the input device 340.

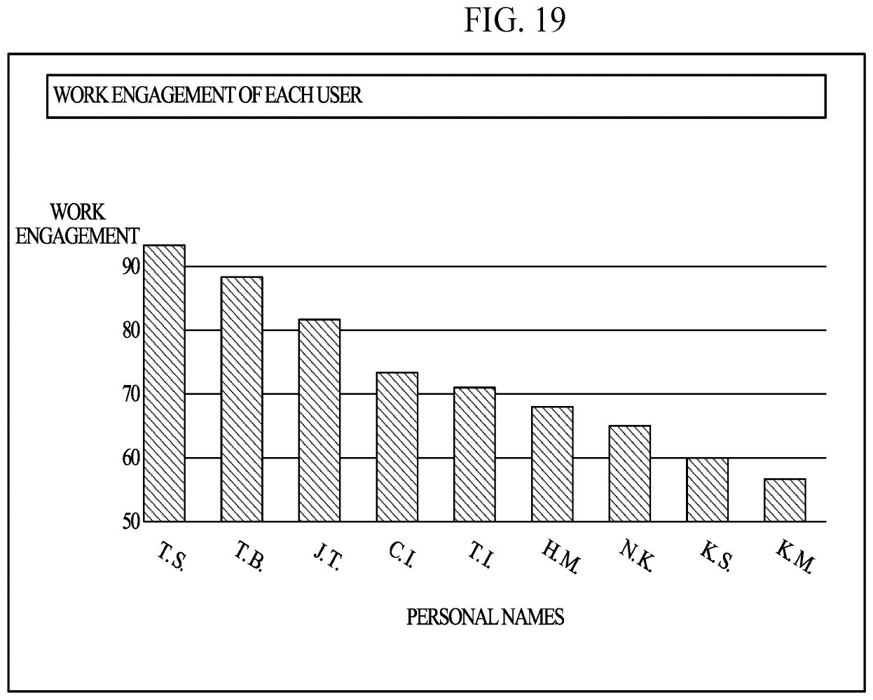

The display controller 125 may cause the display 140 to display a value of work engagement of each user, as shown in FIG. 19, based on the content of input from the input device 150. Similarly, the display controller 314 may cause the display 330 to display a value of work engagement of each user, as shown in FIG. 19, based on the content of input from the input device 340.

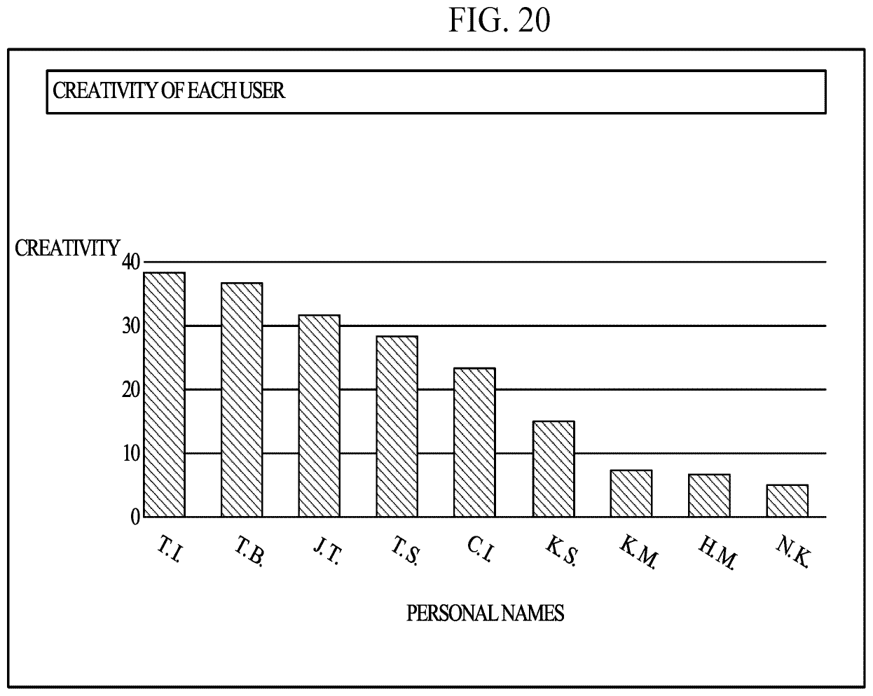

The display controller 125 may cause the display 140 to display a value indicative of creativity of each user, as shown in FIG. 20, based on the content of input from the input device 150. Similarly, the display controller 314 may cause the display 330 to display a value indicative of creativity of each user, as shown in FIG. 20, based on the content of input from the input device 340.

Here, “creativity” is an ability to create a new opinion or new knowledge by integrating information contained in a team including a member or information contained in an organization including the member with information contained in another team or with information contained in another organization. When a member of a team or of an organization has a conversation not only with another member of the team or of the organization, but also with a member of another team or of another organization, the member of the team or of the organization can acquire much information contained in another team or much information contained in another organization. Thus, creativity increases when opinions and knowledge contained in various teams or in various organizations are combined with each other.

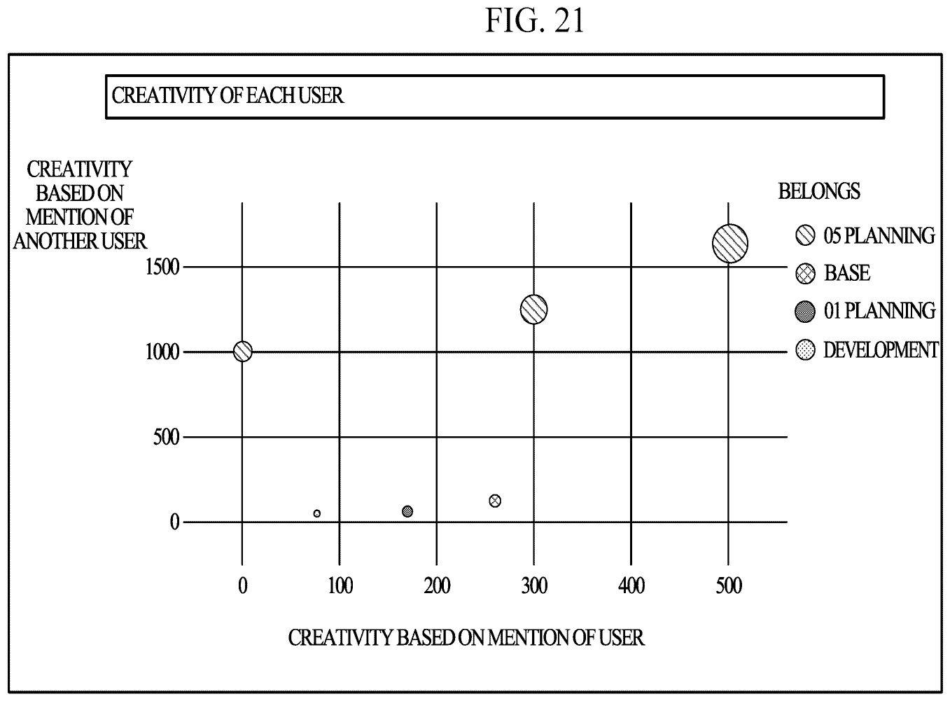

The display controller 125 may cause the display 140 to display a value indicative of creativity of each user, as shown in FIG. 21, based on the content of input from the input device 150. In FIG. 21, a horizontal axis shows values indicative of creativity based on a mention of a user, and a vertical axis shows values indicative of creativity based on a mention of another user. Here, “creativity based on a mention of a user” is calculated by Formula 2 described above. On the other hand, to calculate “creativity based on a mention of another user,” the denominator of Formula 2 described above is changed to “the number of received mentions when on a team” and the numerator of Formula 2 is changed to “the number of received mentions from someone external to the team.” Here, “the number of received mentions when on a team” is the number of mentions received by the new member from one or more members of the team including the new member, each of the mentions being a response to a mention of the new member. On the other hand, “the number of received mentions from someone external to the team” is the number of mentions received by the new member from one or more members of one or more teams, the one or more teams not including the new member, each of the mentions being a response to a mention of the new member. Similarly, the display controller 314 may cause the display 330 to display a value indicative of creativity of each user, as shown in FIG. 21, based on the content of input from the input device 340. The size of each circle shown in FIG. 21 indicates a total value of a value of the vertical axis and a value of the horizontal axis.

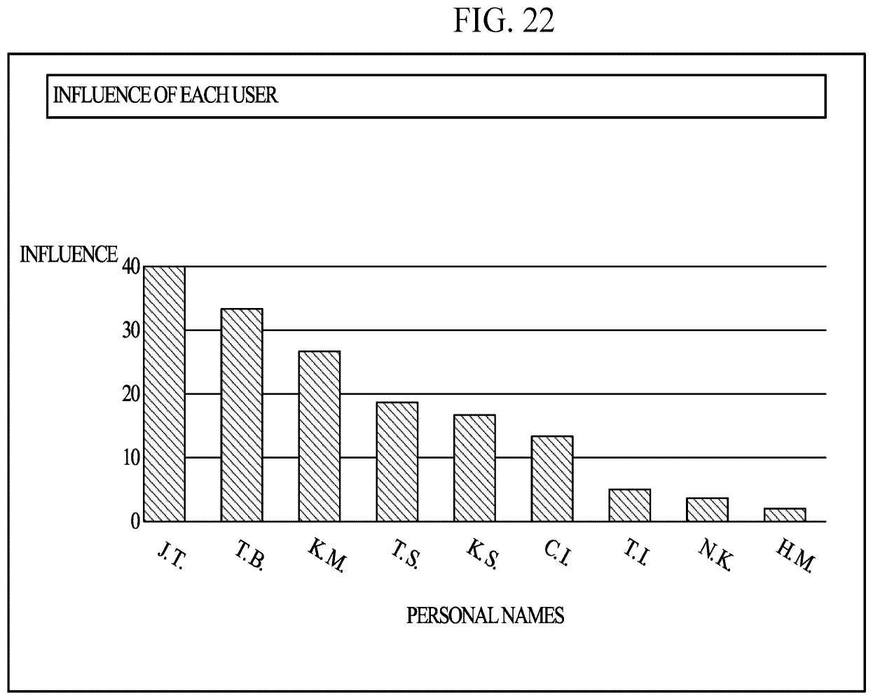

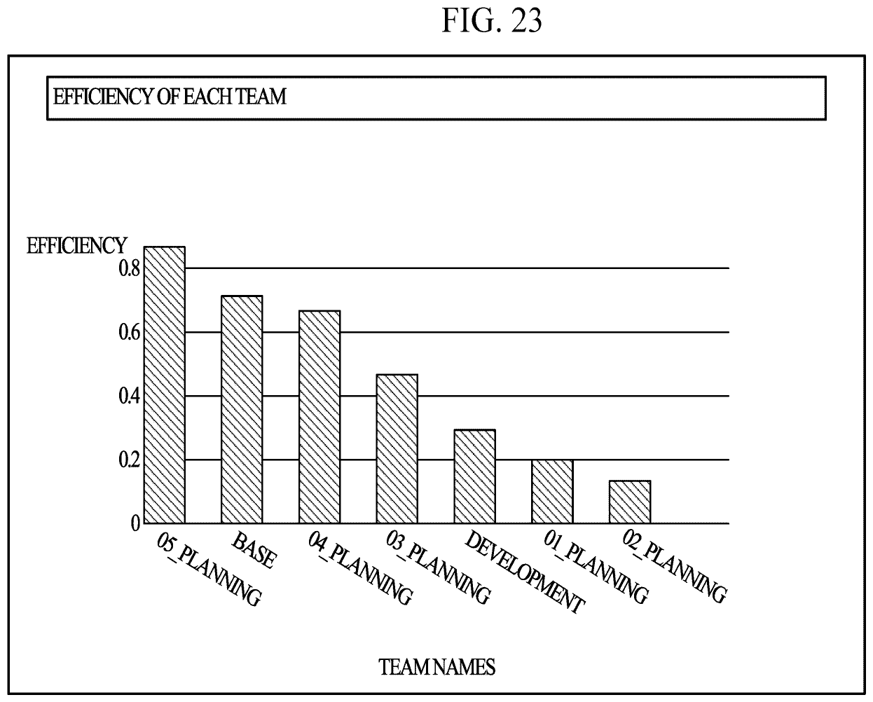

The display controller 125 may cause the display 140 to display a value indicative of an influence of each user, as shown in FIG. 22, based on the content of input from the input device 150. Similarly, the display controller 314 may cause the display 330 to display a value indicative of an influence of each user, as shown in FIG. 22, based on the content of input from the input device 340.

Here, “influence” is an ability of a person, the ability being an ability not only to have strong connections with others, but also to strongly connect a connection of the person with connections of others even if the person belongs to a small number of people (“Harvard Business Review Human Resource Development and Human Resource Textbook”, Chapter 5 People Analysis changes human resources strategy, Diamond Co., 2020).

The display controller 125 may cause the display 140 to display a value indicative of efficiency of each team, as shown in FIG. 23, based on the content of input from the input device 150. Similarly, the display controller 314 may cause the display 330 to display a value indicative of efficiency of each team, as shown in FIG. 23, based on the content of input from the input device 340.

Here, “efficiency” is an ability to perform work efficiently on a team unit. The greater the external range described above of a team, the greater a probability that each member of the team exchanges mentions with external experts. Thus, the team can obtain information necessary for work and can secure resources necessary to meet a deadline, for example.

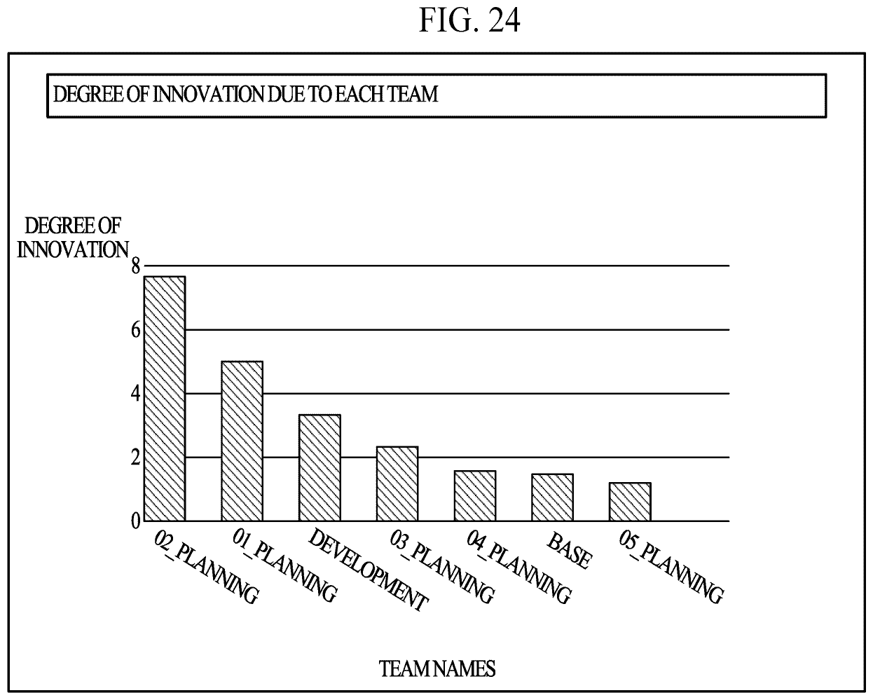

The display controller 125 may cause the display 140 to display a value indicative of a degree of innovation due to each team, as shown in FIG. 24, based on the content of input from the input device 150. Similarly, the display controller 314 may cause the display 330 to display a value indicative of a degree of innovation due to each team, as shown in FIG. 24, based on the content of input from the input device 340.

Here, “innovation” is an ability to create ways to reach breakthroughs from different opinions or conflicts. To this end, it is effective to take advantage of the external area to acquire help or support.

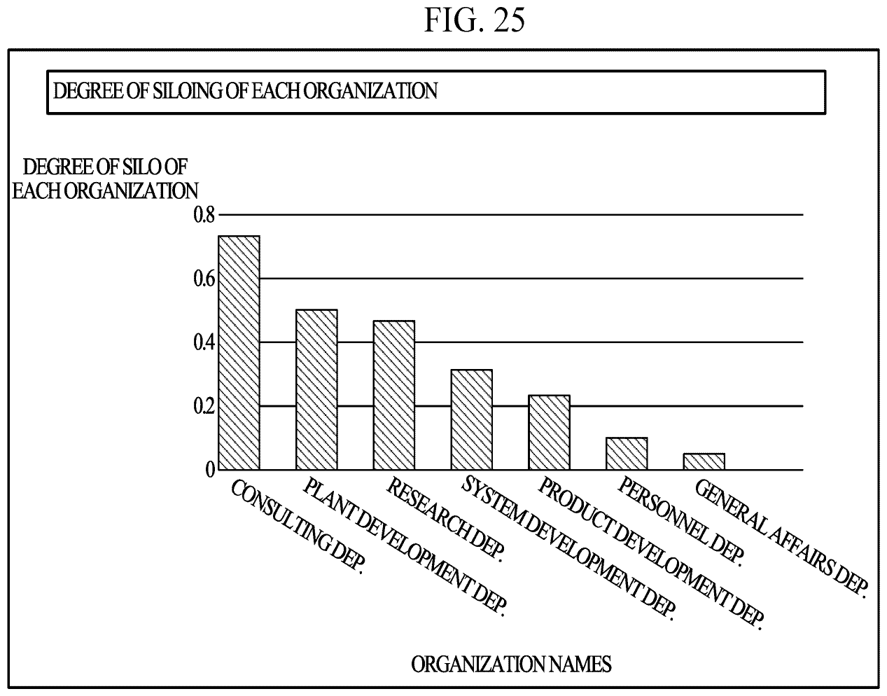

The display controller 125 may cause the display 140 to display a value indicative of a degree of siloing of each organization, as shown in FIG. 25, based on the content of input from the input device 150. Similarly, the display controller 314 may cause the display 330 to display a value indicative of a degree of siloing of each organization, as shown in FIG. 25, based on the content of input from the input device 340.

Here, “silo” means a degree of so-called “sectionalism” generated by the difficulty of cooperative work among organizations due to one of the organizations having excessive devotion to expertise.

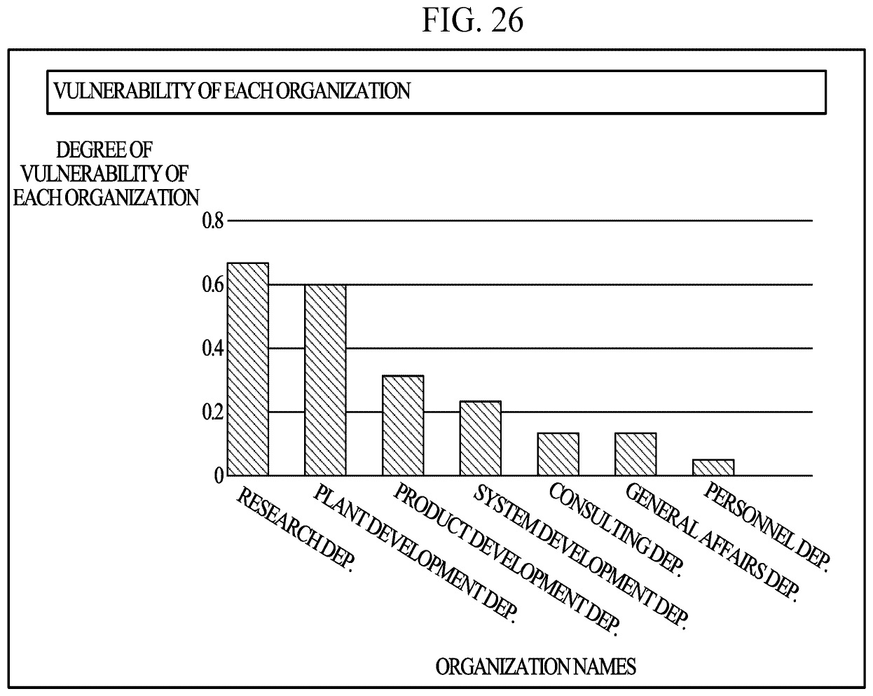

The display controller 125 may cause the display 140 to display a value indicative of a degree of vulnerability of each organization, as shown in FIG. 26, based on the content of input from the input device 150. Similarly, the display controller 314 may cause the display 330 to display a value indicative of a degree of vulnerability of each organization, as shown in FIG. 26, based on the content of input from the input device 340.

Here, “vulnerability” is a degree of dependence on a member who promotes movement of information or movement of knowledge from one part of an organization to another part of the organization.

### 4. Effects Provided by Embodiment

According to the above description, the ability evaluating apparatus 10 includes the first data acquirer 112 configured to, based on conversation data in a chat system, acquire the number of mentions, the chat system being used by an organization constituted of a plurality of teams, the mentions being provided by an evaluation target member to each of the plurality of teams within a first period, the evaluation target member being a member of one of the plurality of teams. The ability evaluating apparatus 10 further includes the first calculator 113 configured to, based on the number of mentions provided by the evaluation target member to each of the plurality of teams, calculate a first proportion that is a proportion of the number of mentions provided by the evaluation target member to each of the plurality of teams. The ability evaluating apparatus 10 further includes the estimator 115 configured to, based on a relationship between a second proportion and a second indicator value, estimate a first indicator value corresponding to the first proportion, the second proportion being a proportion of a number of mentions provided by one member among a plurality of members of the organization to each of the plurality of teams within a second period previous to the first period, the second indicator value being indicative of work engagement representative of a work-related state of mind of the one member among the plurality of members, the first indicator value being indicative of work engagement of the evaluation target member.

The ability evaluating apparatus 10 can reduce a burden on a member of an organization by using the configuration described above to estimate an indicator value indicative of work engagement of the member. In addition, compared to a method of acquiring a value indicative of work engagement through a questionnaire or a test, the ability evaluating apparatus 10 can increase the frequency of updating data, and can calculate a score that always reflects the present state. Furthermore, the ability evaluating apparatus 10 can understand a subtle change in a member of an organization by paying attention to a change in the value indicative of work engagement over time. As a result, the ability evaluating apparatus 10 can detect a mental health problem of the member early and detect a sign of quitting a job early.

The estimator 115 may be configured to estimate the first indicator value for the evaluation target member using a trained model trained by machine learning to learn a relationship between a proportion of a number of mentions provided by one member among a plurality of members of the organization to each of the plurality of teams and an indicator value indicative of work engagement of the one member.

By using the trained model generated by machine learning, the ability evaluating apparatus 10 can estimate an indicator value indicative of work engagement based on an autonomous insight.

The ability evaluating apparatus 10 may further include the trained model generator 114 configured to generate the trained model by causing a model to learn training data by machine learning, the training data being, for each member of the plurality of members, indicative of a combination of a third proportion and a third indicator value, the third proportion being a proportion of a number of mentions provided the member to each of the plurality of teams, the third indicator value being indicative of work engagement of the member.

Since the ability evaluating apparatus 10 includes the trained model generator 114 configured to generate the trained model, the ability evaluating apparatus 10 can perform both an operation in a learning phase and an operation in a use phase.

The ability evaluating apparatus 10 may also include the second data acquirer 116 configured to, based on the conversation data in the chat system, acquire the number of mentions when on a team and the number of mentions when not on the team, the number of mentions when on a team being the number of mentions provided by the evaluation target member to one or more members of one team, the one team including the evaluation target member, the number of mentions when not on the team being the number of mentions provided by the evaluation target member to one or more members of one or more teams, the one or more teams not including the evaluation target member. The ability evaluating apparatus 10 may further include the second calculator 117 configured to use the number of mentions when on a team and the number of mentions when not on the team to calculate an indicator value indicative of creativity of the evaluation target member.

By including the second data acquirer 116 and the second calculator 117, the ability evaluating apparatus 10 can calculate an indicator value indicative of creativity that is an ability to create a new opinion or new knowledge by integrating information contained in a team including an evaluation target member or information contained in an organization including the evaluation target member with information contained in another team or with information contained in another organization.

The ability evaluating apparatus 10 may further include the third data acquirer 118 configured to, based on the conversation data in the chat system, acquire, for each mention of mentions of the evaluation target member, the number of citations and a citation relationship, the number of citations being a number of citations from the mention of the evaluation target member, the citation relationship being a relationship between the evaluation target member and one or more members citing the mention of the evaluation target member. The ability evaluating apparatus 10 may further include the third calculator 119 configured to use the number of citations and the citation relationship to calculate PageRank of the evaluation target member as an indicator value indicative of the influence of the evaluation target member.

By including the third data acquirer 118 and the third calculator 119, the ability evaluating apparatus 10 can calculate an indicator value indicative of an influence that is an ability of a person, the ability being an ability not only to have a strong connection with others, but also to strongly connect connections of the person with connections of others even if the person is one among a small number of people.

The ability evaluating apparatus 10 may further include the fourth data acquirer 120 configured to, based on the conversation data in the chat system, acquire, for each team of the plurality of teams, a first numerical value of an external range and a second numerical value of degree centrality, the first numerical value of an external range being a number of members of one or more teams other than the team of the plurality of teams, the members of the one or more teams other than the team of the plurality of teams having had a conversation with one or more member of the team of the plurality of teams, the second numerical value of degree centrality being a number of one or more teams other than the team of the plurality of teams. The ability evaluating apparatus 10 may further include the fourth calculator 121 configured to use the first numerical value of an external range and the second numerical value of degree centrality to calculate at least one of an indicator value indicative of efficiency of the team of the plurality of teams or an indicator value indicative of a degree of innovation due to the team of the plurality of teams.

By including the fourth data acquirer 120 and the fourth calculator 121, the ability evaluating apparatus 10 can calculate both an indicator value indicative of efficiency that is an ability to perform work efficiently on a team unit and an indicator value indicative of a degree of innovation that is an ability to create ways to reach breakthroughs from different opinions or conflicts.

The ability evaluating apparatus 10 may further include the fifth data acquirer 122 configured to, based on the conversation data in the chat system, acquire, for each organization, a second numerical value of an external range and a second numerical value of degree centrality, the second numerical value of an external range being a number of members of one or more different organizations, the members of the one or more different organizations having had a conversation with one or more members of the organization, the second numerical value of degree centrality being a number of one or more different organizations. The ability evaluating apparatus 10 may further include the fifth calculator 123 configured to use the second numerical value of an external range and the second numerical value of degree centrality to calculate an indicator value indicative of a degree of siloing as a degree of isolation of the organization.

By including the fifth data acquirer 122 and the fifth calculator 123, the ability evaluating apparatus 10 can calculate an indicator value indicative of a degree of isolation as a degree of “sectionalism” generated by the difficulty of cooperative work among organizations due to one of the organizations having excessive devotion to expertise.

The ability evaluating apparatus 10 may further include the sixth data acquirer 124 configured to, based on the conversation data in the chat system, acquire, for each organization, the number of members of the organization as an indicator value indicative of vulnerability, the members of the organization having had a conversation with one or more members of a different organization, the indicator value indicative of vulnerability being an indicator value indicative of vulnerability against the different organization.

By including the sixth data acquirer 124, the ability evaluating apparatus 10 can calculate an indicator value indicative of vulnerability as a degree of dependence on a member who promotes movement of information or movement of knowledge from one part of an organization to another part of the organization.

### 5. Modifications

The present disclosure is not limited to the embodiment described above. Specific modifications will be explained below. Two or more modifications freely selected from the following modifications may be combined.

### 5.1 Modification 1

In the above embodiment, the ability evaluating apparatus 10 includes the analyzer 111. However, the ability evaluating apparatus 10 is not limited to a configuration including the analyzer 111. For example, instead of the ability evaluating apparatus 10, the server 20 may include an analyzer similar to the analyzer 111. More specifically, when a data request is transmitted from the ability evaluating apparatus 10 to the server 20, the analyzer of the server 20 may calculate data, which is similar to the data calculated by the analyzer 111, based on the mention history database DB1, the mention content database DB2, and records of the user information database DB3 that are stored in the storage device 220. The analyzer of the server 20 may transmit the calculated data, as response data, to the ability evaluating apparatus 10.

### 5.2 Modification 2

In the above embodiment, the ability evaluating apparatus 10 is configured to estimate the first indicator value indicative of the work engagement of a new member who newly joins one of the plurality of teams, the work engagement of the new member corresponding to the proportion of the number of mentions provided by the new member to each of the plurality of teams. However, the ability evaluating apparatus 10 is not limited to a configuration that estimates the first indicator value indicative of the work engagement of the new member. For example, the ability evaluating apparatus 10 may estimate an indicator value corresponding to a proportion of the number of mentions provided by a member of a team to each team within a period of time, the member belonging to the team from a long time ago, an indicator value indicative of work engagement of the member being already calculated based on a questionnaire, etc., the period of time being after a period of time of the questionnaire. Regarding the member belonging to the team from a long time ago, the ability evaluating apparatus 10 may calculate an indicator value indicative of creativity, an indicator value indicative of an influence, etc., in addition to the indicator value indicative of work engagement.

### 5.3 Modification 3

In the above embodiment, the server 20 is a configuration including the mention history database generator 211, the mention content database generator 212, the mention history database DB1, the mention content database DB2, and the user information database DB3. However, the server 20 is not limited to the configuration including these components. For example, the ability evaluating apparatus 10 may include these components. Alternatively, a second server, separate from the server 20, may include these components.

### 5.4 Modification 4

In the above embodiment, the trained model generator 114 generates the trained model LM1 by causing a model to learn, by machine learning, the training data indicative of a combination of a proportion of the number of mentions provided by a member to each team and an indicator value indicative of work engagement of the member. The estimator 115 uses the trained model LM1 to estimate an indicator value indicative of work engagement of a member. However, a configuration of the estimator 115 is not limited to a configuration that uses the trained model LM1. For example, the estimator 115 may estimate an indicator value indicative of work engagement of a member by referring to a table in which a relationship between a proportion of the number of mentions provided by one member to each team and an indicator value indicative of work engagement of the one member is written for each member. The table is stored in the storage device 130 in advance.

### 5.5 Modification 5

In the above embodiment, the display controller 314 is a configuration that, based on the content of input from the input device 340, causes the display 330 to display graphs of the number of mentions for each channel, the number of mentions for each user, the number of mentions for each channel used by a particular user, the number of mentions for each user in a particular channel, a value of work engagement of each user, a value indicative of creativity of each user, a value indicative of an influence of each user, a value indicative of efficiency of each team, a value indicative of a degree of innovation due to each team, a value indicative of a degree of siloing of each organization, and a value indicative of vulnerability of each organization. However, the display controller 314 is not limited to this configuration. For example, the display controller 314 may perform natural language processing on conversation data in a chat system to cause the display 330 to display the number of mentions for each topic based on a result of the natural language processing.

### 5.6 Modification 6

In the above embodiment, the estimator 115 estimates the indicator value indicative of work engagement of the new member, the work engagement of the new member corresponding to the proportion of the number of mentions provided by the new member to each team. The second calculator 117 uses the number of mentions when on a team and the number of mentions when not on the team to calculate the indicator value indicative of creativity of the new member. The third calculator 119 uses the number of citations and the citation relationship to calculate the PageRank of the new member as an indicator value indicative of an influence of the new member. The fourth calculator 121 uses the numerical value A1 of an external range and the numerical value A2 of degree centrality to calculate the indicator value indicative of efficiency of the team, the indicator value indicative of a degree of innovation due to the team, or a combination thereof. The fifth calculator 123 uses the numerical value B1 of an external range and the numerical value B2 of degree centrality to calculate the indicator value indicative of a degree of siloing as a degree of isolation of an organization. The sixth data acquirer 124 acquires, for each organization, the number of members of the organization having had a conversation with one or more members of a different organization from the organization, as an indicator value indicative of vulnerability against the different organization. However, the embodiment of the present invention is not limited to this configuration. For example, to calculate the indicator values described above, the above components may use the number of channels, the channels being registered by each member. For example, the estimator 115 may estimate an indicator value indicative of the work engagement of the new member, the work engagement of the new member corresponding to both the proportion of the number of mentions provided by the new member to each team and the number of channels registered by the new member. Furthermore, the above components may perform weighting for each channel to use weighted channels as factors used to calculate each of the indicator values described above. For example, when calculating the indicator value indicative of the influence of the new member using the number of citations and the citation relationship, the third calculator 119 may weigh the number of citations and the citation relationship in accordance with channels through which mentions of the new member pass to cite the mentions of the new member.

### 6. Other Matters

(1) In the foregoing embodiment, the storage devices 130, 220, and 320 are each, for example, a ROM and a RAM; however, the storage devices may include flexible disks, magneto-optical disks (e.g., compact disks, digital multi-purpose disks, Blu-ray (registered trademark) discs, smart-cards, flash memory devices (e.g., cards, sticks, key drives), Compact Disc-ROMs (CD-ROMs), registers, removable discs, hard disks, floppy (registered trademark) disks, magnetic strips, databases, servers, or other suitable storage mediums. The program may be transmitted from a network via telecommunication lines. Alternatively, the program may be transmitted from a communication network via telecommunication lines.

(2) In the foregoing embodiment, information, signals, etc., may be presented by use of various techniques. For example, data, instructions, commands, information, signals, bits, symbols, chips, etc., may be presented by freely selected combination of voltages, currents, electromagnetic waves, magnetic fields or magnetic particles, light fields or photons.

(3) In the foregoing embodiment, the input and output of information, or the input or output of information, etc., may be stored in a specific location (e.g., memory) or may be managed by use of a management table. The information, etc., that is, the input and the output, or the input or the output, may be overwritten, updated, or appended. The information, etc., that is output may be deleted. The information, etc., that is input may be transmitted to other devices.

(4) In the foregoing embodiment, determination may be made based on values that can be represented by one bit (0 or 1), may be made based on Boolean values (true or false), or may be made based on comparing numerical values (for example, comparison with a predetermined value).

(5) The order of processes, sequences, flowcharts, etc., that have been used to describe the foregoing embodiment may be changed as long as they do not conflict. For example, although a variety of methods has been illustrated in this disclosure with a variety of elements of steps in exemplary orders, the specific orders presented herein are by no means limiting.

(6) Each function shown in FIGS. 2, 8, and 11 is implemented by any combination of hardware and software. The method for realizing each functional block is not limited thereto. That is, each functional block may be implemented by one device that is physically or logically aggregated. Alternatively, each functional block may be realized by directly or indirectly connecting two or more physically and logically separate, or physically or logically separate, devices (by using cables and radio, or cables, or radio, for example), and using these devices. The functional block may be realized by combining the software with one device described above or two or more of these devices.

(7) The programs shown in the foregoing embodiment should be widely interpreted as an instruction, an instruction set, a code, a code segment, a program code, a subprogram, a software module, an application, a software application, a software package, a routine, a subroutine, an object, an executable file, an execution thread, a procedure, a function, or the like, regardless of whether it is called software, firmware, middleware, microcode, hardware description language, or other names.

Software, instructions, etc., may be transmitted and received via communication media. For example, when software is transmitted from a website, a server, or other remote sources, by using wired technologies such as coaxial cables, optical fiber cables, twisted-pair cables, and digital subscriber lines (DSL), and wireless technologies such as infrared radiation and radio and microwaves by using wired technologies, or by wireless technologies, these wired technologies and wireless technologies, wired technologies, or wireless technologies, are also included in the definition of communication media.

(8) In each aspect, the terms “system” and “network” are used interchangeably.

(9) The information and parameters described in this disclosure may be represented by absolute values, may be represented by relative values with respect to predetermined values, or may be represented by using other pieces of applicable information.

(10) In the foregoing embodiment, the ability evaluating apparatus 10, the server 20, and the user terminal devices 30-1 through 30-n may each be a mobile station (MS). A mobile station may be referred to, by one skilled in the art, as a “subscriber station”, a “mobile unit”, a “subscriber unit”, a “wireless unit”, a “remote unit”, a “mobile device”, a “wireless device”, a “wireless communication device”, a “remote device”, a “mobile subscriber station”, an “access terminal”, a “mobile terminal”, a “wireless terminal”, a “remote terminal”, a “handset”, a “user agent”, a “mobile client”, a “client”, or some other suitable terms. The terms “mobile station”, “user terminal”, “user equipment (UE)”, “terminal”, etc., may be used interchangeably in the present disclosure.

(11) In the foregoing embodiment, the terms “connected” and “coupled”, or any modification of these terms, may mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be replaced with “access.” As used in this specification, two elements may be considered “connected” or “coupled” to each other by using one or more electrical wires, cables, and printed electrical connections, or by using one or more electrical wires, cables, or printed electrical connections. In addition, two elements may be considered “connected” or “coupled” to each other by using electromagnetic energy, etc., which is a non-limiting and non-inclusive example, having wavelengths in radio frequency regions, microwave regions, and optical (both visible and invisible) regions.

(12) In the foregoing embodiment, the phrase “based on” as used in this specification does not mean “based only on”, unless specified otherwise. In other words, the phrase “based on” means both “based only on” and “based at least on.”

(13) The term “determining” as used in this specification may encompass a wide variety of actions. For example, the term “determining” may be used when practically “determining” that some act of calculating, computing, processing, deriving, investigating, looking up (for example, looking up a table, a database, or some other data structure), ascertaining, etc., has taken place. Furthermore, “determining” may be used when practically “determining” that some act of receiving (for example, receiving information), transmitting (for example, transmitting information), inputting, outputting, accessing (for example, accessing data in a memory) etc., has taken place. Furthermore, “determining” may be used when practically “determining” that some act of resolving, selecting, choosing, establishing, comparing, etc., has taken place. That is, “determining” may be used when practically determining to take some action. The term “determining” may be replaced with “assuming”, “expecting”, “considering”, etc.

(14) As long as terms such as “include”, “including” and modifications thereof are used in the foregoing embodiment, these terms are intended to be inclusive, in a manner similar to the way the term “comprising” is used. In addition, the term “or” used in the specification or in claims is not intended to be an exclusive OR.

(15) In the present disclosure, for example, when articles such as “a”, “an”, and “the” in English are added in translation, these articles include plurals unless otherwise clearly indicated by the context.

(16) In this disclosure, the phrase “A and B are different” may mean “A and B are different from each other.” The phrase “A and B are different from C, respectively” may mean that “A and B are different from C”. Terms such as “separated” and “combined” may be interpreted in the same way as “different.”

(17) The examples and embodiments illustrated in this specification may be used individually or in combination, which may be altered depending on the mode of implementation. A predetermined piece of information (for example, a report to the effect that something is “X”) does not necessarily have to be indicated explicitly, and may be indicated in an implicit way (for example, by not reporting this predetermined piece of information, by reporting another piece of information, etc.).

Although this disclosure is described in detail, it is obvious to those skilled in the art that the present invention is not limited to the embodiments described in the specification. This disclosure can be implemented with a variety of corrections and in a variety of modifications, without departing from the spirit and scope of the present invention defined as in the recitations of the claims. Consequently, the description in this specification is provided only for the purpose of explaining examples and should by no means be construed to limit the present invention in any way.

### DESCRIPTION OF REFERENCE SIGNS

1 . . . ability evaluating system, 10 . . . ability evaluating apparatus, 20 . . . server, 30, 30-1, 30-n . . . user terminal device, 110 . . . processor, 111 . . . analyzer, 112 . . . first data acquirer, 113 . . . first calculator, 114 . . . trained model generator, 115 . . . estimator, 116 . . . second data acquirer, 117 . . . second calculator, 118 . . . third data acquirer, 119 . . . third calculator, 120 . . . fourth data acquirer, 121 . . . fourth calculator, 122 . . . fifth data acquirer, 123 . . . fifth calculator, 124 . . . sixth data acquirer, 125 . . . display controller, 130 . . . storage device, 140 . . . display, 150 . . . input device, 160 . . . communication device, 210 . . . processor, 211 . . . conversation data processor, 212 . . . mention history database generator, 220 . . . storage device, 230 . . . communication device, 310 . . . processor, 311 . . . mention data generator, 312 . . . conversation data acquirer, 313 . . . process data acquirer, 314 . . . display controller, 320 . . . storage device, 330 . . . display, 340 . . . input device, 350 . . . communication device, DB1 . . . mention history database, DB2 . . . mention content database, DB3 . . . user information database, LM1 . . . trained model, PR1,PR2,PR3 . . . control program.

1. An ability evaluating apparatus comprising:
a first data acquirer configured to, based on conversation data in a chat system, acquire a number of mentions, the chat system being used by an organization constituted of a plurality of teams, the mentions being provided by an evaluation target member to each of the plurality of teams within a first period, the evaluation target member being a member of one of the plurality of teams;
a first calculator configured to, based on the number of mentions provided by the evaluation target member to each of the plurality of teams, calculate a first proportion that is a proportion of the number of mentions provided by the evaluation target member to each of the plurality of teams; and
an estimator configured to, based on a relationship between a second proportion and a second indicator value, estimate a first indicator value corresponding to the first proportion, the second proportion being a proportion of a number of mentions provided by one member among a plurality of members of the organization to each of the plurality of teams within a second period previous to the first period, the second indicator value being indicative of work engagement representative of a work-related state of mind of the one member among the plurality of members, the first indicator value being indicative of work engagement of the evaluation target member.

2. The ability evaluating apparatus according to claim 1, wherein the estimator is configured to estimate the first indicator value for the evaluation target member using a trained model trained by machine learning to learn the relationship.

3. The ability evaluating apparatus according to claim 2, further comprising a trained model generator configured to generate the trained model by causing a model to learn training data by machine learning, the training data being, for each member of the plurality of members, indicative of a combination of a third proportion and a third indicator value, the third proportion being a proportion of a number of mentions provided by the member to each of the plurality of teams, the third indicator value being indicative of work engagement of the member.

4. The ability evaluating apparatus according to claim 1, further comprising:
a second data acquirer configured to, based on the conversation data in the chat system, acquire a number of mentions when on a team and a number of mentions when not on the team, the number of mentions when on the team being a number of mentions provided by the evaluation target member to one or more members of one team, the one team including the evaluation target member, the number of mentions when not on the team being a number of mentions provided by the evaluation target member to one or more members of one or more teams, the one or more teams not including the evaluation target member; and
a second calculator configured to use the number of mentions when on the team and the number of mentions when not on the team to calculate an indicator value indicative of creativity of the evaluation target member.

5. The ability evaluating apparatus according to claim 1, further comprising:
a third data acquirer configured to, based on the conversation data in the chat system, acquire, for each mention of mentions of the evaluation target member, a number of citations and a citation relationship, the number of citations being a number of citations from the mention of the evaluation target member, the citation relationship being a relationship between the evaluation target member and one or more members citing the mention of the evaluation target member; and
a third calculator configured to use the number of citations and the citation relationship to calculate PageRank of the evaluation target member as an indicator value indicative of an influence of the evaluation target member.

6. The ability evaluating apparatus according to claim 1, further comprising:
a fourth data acquirer configured to, based on the conversation data in the chat system, acquire, for each team of the plurality of teams, a first numerical value of an external range and a first numerical value of degree centrality, the first numerical value of an external range being a number of members of one or more teams other than the team of the plurality of teams, the members of the one or more teams other than the team of the plurality of teams having had a conversation with one or more member of the team of the plurality of teams, the first numerical value of degree centrality being a number of one or more teams other than the team of the plurality of teams; and
a fourth calculator configured to use the first numerical value of an external range and the first numerical value of degree centrality to calculate at least one of an indicator value indicative of efficiency of the team of the plurality of teams or an indicator value indicative of a degree of innovation due to the team of the plurality of teams.

7. The ability evaluating apparatus according to claim 1, wherein:
the organization is one of a plurality of first organizations, and
the ability evaluating apparatus further comprises:
a fifth data acquirer configured to, based on conversation data in the chat system, acquire, for each first organization of the plurality of first organizations, a second numerical value of an external range and a second numerical value of degree centrality, the second numerical value of an external range being a number of members of one or more first organizations other than the first organization of the plurality of first organizations, the members of the one or more first organizations other than the first organization of the plurality of first organizations having had a conversation with one or more members of the first organization of the plurality of first organizations, the second numerical value of degree centrality being a number of one or more first organizations other than the first organization of the plurality of first organizations; and
a fifth calculator configured to use the second numerical value of an external range and the second numerical value of degree centrality to calculate an indicator value indicative of a degree of siloing as a degree of isolation of the first organization of the plurality of first organizations.

8. The ability evaluating apparatus according to claim 1, wherein:
the organization is one of a plurality of second organizations, and
the ability evaluating apparatus further comprises a sixth data acquirer configured to, based on the conversation data in the chat system, acquire, for each second organization of the plurality of second organizations, a number of members of the second organization of the plurality of second organizations as an indicator value indicative of vulnerability, the members of the second organization of the plurality of second organizations having had a conversation with one or more members of a second organization other than the second organization of the plurality of second organizations, the indicator value indicative of vulnerability being an indicator value indicative of vulnerability against the second organization other than the second organization of the plurality of second organizations.

9. The ability evaluating apparatus according to claim 2, further comprising:
a second data acquirer configured to, based on the conversation data in the chat system, acquire a number of mentions when on a team and a number of mentions when not on the team, the number of mentions when on the team being a number of mentions provided by the evaluation target member to one or more members of one team, the one team including the evaluation target member, the number of mentions when not on the team being a number of mentions provided by the evaluation target member to one or more members of one or more teams, the one or more teams not including the evaluation target member; and
a second calculator configured to use the number of mentions when on the team and the number of mentions when not on the team to calculate an indicator value indicative of creativity of the evaluation target member.

10. The ability evaluating apparatus according to claim 3, further comprising:
a second data acquirer configured to, based on the conversation data in the chat system, acquire a number of mentions when on a team and a number of mentions when not on the team, the number of mentions when on the team being a number of mentions provided by the evaluation target member to one or more members of one team, the one team including the evaluation target member, the number of mentions when not on the team being a number of mentions provided by the evaluation target member to one or more members of one or more teams, the one or more teams not including the evaluation target member; and
a second calculator configured to use the number of mentions when on the team and the number of mentions when not on the team to calculate an indicator value indicative of creativity of the evaluation target member.
